(19) United States
(12) Patent Application Publication
(10) Pub. No.: US 2004/0125877 A1
(43) Pub. Date: Jul. 1, 2004

(54) Method and system for indexing and content-based adaptive streaming of digital video content

(76) Inventors: Shin-Fu Chang, New York, NY (US); Di Zhong, Jersey City, NJ (US); Raj Kumar, New York, NY (US); Alejandro Jaimes, New York, NY (US)

Correspondence Address: BAKER & BOTTS, 30 ROCKEFELLER PLAZA, NEW YORK, NY, 10112

(21) Appl. No.: 10/333,030

(22) PCT Filed: Apr. 9, 2001
(86) PCT No.: PCT/US01/11485

(51) Int. Cl. H04N 7/12

(52) U.S. Cl. 375/240.28; 375/240.26; 375/240.01

(57) ABSTRACT

The present invention discloses systems and methods for automatically parsing digital video content into segments corresponding to fundamental semantic units, events, and camera views, and streaming parsed digital video content to users for display and browsing. The systems and methods effectively use the domain-specific knowledge such as regular structures of fundamental semantic units, unique views corresponding to the units, and the predictable state transition rules. The systems and methods also include scene change detection, video text recognition, and view recognition. The results of parsing may be used in a personal video browsing/navigation interface system. Furthermore, a novel adaptive streaming method in which quality levels of video segments are varied dynamically according to the user preference of different segments is disclosed. Important segments are transmitted with full-motion audio-video content at a high bit rate, while the rest is transmitted only as low-bandwidth media (text, still frames, audio).

### CROSS-REFERENCES TO RELATED APPLICATIONS

This application is based on U.S. Provisional Application Serial No. 60/218,969, filed Jul. 17, 2000, and U.S. Provisional Application Serial No. 60/260,637, filed Jan. 3, 2001, which are incorporated herein by reference for all purposes and from which priority is claimed.

### 1. FIELD OF THE INVENTION

This invention relates generally to video indexing and streaming, and more particularly to feature extraction, scene recognition, and adaptive encoding for high-level video segmentation, event detection, and streaming.

### 2. BACKGROUND OF THE INVENTION

Digital video is emerging as an important media type on the Internet as well as in other media industries such as broadcast and cable. Today, many web sites include streaming content. An increased number of content providers are using digital video and various forms of media that integrate video components. Video capturing and production tools are becoming popular in professional as well as consumer circles. With an increase of bandwidth in backbone networks as well as last mile connections, video streaming is also gaining momentum at a rapid pace.

Digital video can be roughly classified into two categories: on-demand video and live video. On-demand video refers to video programs that are captured, processed and stored, and which may be delivered upon user's request. Most of the video clips currently available on the Internet belong to this class of digital video. Some examples include CNN video site and Internet film archives. Live video refers to video programs that are immediately transmitted to users. Live video may be used in live broadcast events such as video webcasting or in interactive video communications such as video conferencing. As the volume and scale of available digital video increase, the issues of video content indexing and adaptive streaming become very important.

With respect to video content indexing, digital video requires high bandwidth and computational power. Sequential viewing is not an adequate solution for long video programs or large video collections. Furthermore, without efficient management and indexing tools, applications cannot be scaled up to handle large collections of video content.

With respect to video streaming, most video streaming techniques are limited to low-resolution stamp-size video. This is mainly due to the bandwidth constraints imposed by server capacity, backbone infrastructure, last-mile connection, and client device capacity. These problems are particularly acute for wireless applications.

For these reasons, there have been several attempts to provide new tools and systems for indexing and streaming video content.

In the video indexing research field, there have been two general approaches to video indexing. One approach focuses on decomposition of video sequences into short shots by detecting a discontinuity in visual and/or audio features. Another approach focuses on extracting and indexing video objects based on their features. However, both of these approaches focus on low-level structures and features, and do not provide high-level detection capabilities.

For example, in H. Zhang, C. Y. Low, and S. Smoliar, Video Parsing and Browsing Using Compressed Data, J. of Multimedia Tools and Applications, Vol. 1, No. 1, Kluwer Academic Publishers, March 1995, pp. 89-111, an attempt to segment the video into low-level units, such as video shots, and then summarize the video with hierarchical views is disclosed. Also, in D. Zhong, H. Zhang, and S.-F. Chang, Clustering Methods for Video Browsing and Annotation, SPIE Conference on Storage and Retrieval for Image and Video Database, San Jose, February 1996, and in J. Meng and S.-F. Chang, Tools for Compressed-Domain Video Indexing and Editing, SPIE Conference on Storage and Retrieval for Image and Video Database, San Jose, February 1996, similar attempts are disclosed. A shot is a segment of video data that is captured by a continuous camera take. It is typically a segment of tens of seconds. A shot is a low-level concept and does not represent the semantic structure. A one-hour video program may consist of hundreds of shots. The video shots are then organized into groups at multiple levels in a hierarchical way. The grouping criterion was based on the similarity of low-level visual features of the shots.

In Shingo Uchihashi, Jonathan Foote, Andreas Girgensohn, John Boreczky, Video Manga: Generating Semantically Meaningful Video Summaries, ACM Multimedia Conference, Orlando, Fla., November 1999, a graphic layout of key frames chosen from constituent shots in a video is disclosed. Key frames are representative frames from a shot. This reference provides an approach of analyzing the importance of a shot based on the audio properties (such as emphasized sound) and then adjusting the positions and sizes of the key frames in the final layout according to such properties.

In Wactlar, H., Kanade, T., Smith, M., Stevens, S. Intelligent Access to Digital Video: The Informedia Project, IEEE Computer, Vol. 29, No. 5, May 1996, Digital Library Initiative special issue, an attempt to use textual information extracted from closed caption information, or information derived from speech recognition, as annotation indexes is disclosed.

In Henry A. Rowley, Shumeet Baluja, Takeo Kanade, Human Face Detection in Visual Scenes, CMU Computer Science Department Technical Report, CMU-CS-95-1588, July 1995, a model-based approach for detecting special objects is disclosed. Similarly, in H. Wang and Shih-Fu Chang, A Highly Efficient System for Automatic Face Region Detection in MPEG Video Sequences, IEEE Trans. on Circuits and Systems for Video Technology, special issue on Multimedia Systems and Technologies, Vol. 7, No. 4, pp. 615-628, August 1997, and in M. R. Naphade, T. Kristjansson, B. J. Frey, and T. S. Huang, Probabilistic Multimedia Objects (Multijects): A Novel Approach to Video Indexing and Retrieval in Multimedia Systems, IEEE Intern. Conference on Image Processing, October 1998, Chicago, Ill., model-based approaches to detecting special objects (e.g., faces, cars) or events (e.g., handshakes, explosion) have been disclosed.

Some efforts have been made to segment video into high-level units such as scenes. A scene may consist of multiple shots taken at the same location. Others aim at detecting generic events in audio-visual sequences by integrating multimedia features. For example, the work in M. R. Naphade and T. S. Huang, Semantic Video Indexing using a probabilistic framework, International Conference on Pattern Recognition, Barcelona, Spain, September 2000, uses a statistical reasoning model to combine multimedia features to detect specific events, such as explosions.

There are also some works in analyzing the sports video content. In Y. Gong et al Automatic parsing of TV soccer programs, In Proc. IEEE Multimedia Computing and Systems, May, 1995, Washington D.C. the soccer videos have been analyzed. The system disclosed in this reference classified key-frames of each video shot according to their physical location in the field (right, left, middle) or the presence/absence of the ball. Also, in D. D. Saur, T.-P. Tan et al. Automated Analysis and Annotation of basketball Video, Proceedings of SPIE's Electronic Imaging conference on Storage and Retrieval for Image and Video Databases V, February 1997, a system for detecting events in basketball games (e.g., long pass, steals, fast field changes) was described. Furthermore, a system for classifying each shot of tennis video to different events was proposed in G. Sudhir, J. C. M. Lee and A. K. Jain, Automatic Classification of Tennis Video for High-level Content-based Retrieval, Proc. Of the 1998 International Workshop on Content-based Access of Image and Video Database, Jan. 3, 1998 Bombay, India.

In the video streaming area, there has been much work on low bit rate video coding such as H.263, H.263+, and MPEG-4. There are also new production and streaming tools for capturing digital video, integrating video with other media types, and streaming videos over the Internet. Some examples of such tools are Real Media and Microsoft Windows Media.

There are some systems related to multimedia adaptation, especially transcoding of the multimedia content in a wireless or mobile environment. Some examples include J. R. Smith, R. Mohan and C. Li, Scalable Multimedia Delivery for Pervasive Computing, ACM Multimedia Conference (Multimedia 99), October-November, 1999, Orlando, Fla., and A. Fox and E. A. Brewer, Reducing WWW Latency and Bandwidth Requirements by Real timer Distillation, in Proc. Intl. WWW Conf., Paris, France, May 1996. However, these systems primarily used generic types (e.g., image file formats or generic purposes) or low-level attributes (e.g., bit rate). For example, color images on a web page are transcoded to black-and-white or gray scale images when they are delivered to hand-held devices which do not have color displays. Graphics banners for decoration purposes on a web page are removed to reduce the transmission time of downloading a web page.

Recently, an international standard, called MPEG-7, for describing multimedia content was developed. MPEG-7 specifies the language, syntax, and semantics for description of multimedia content, including image, video, and audio. Certain parts of the standard are intended for describing the summaries of video programs. However, the standard does not specify how the video can be parsed to generate the summaries or the event structures.

While the references relating to parsing and indexing of digital video content allow for parsing and indexing of digital video content, they suffer from a common drawback in that they fail to utilize knowledge about the predictable temporal structures of specific domains, corresponding unique domain-specific feature semantics, or state transition rules. Accordingly, there remains a need for an indexing method and system which take into account the predictable domain-specific event structures and the corresponding unique feature semantics, thus allowing for defining and parsing of fundamental semantic units.

Likewise, none of the above-discussed references relating to video streaming either explore the semantic event and feature structures of video programs or address the issue of content-specific adaptive streaming. Accordingly, there remains a need for a system that provides content-specific adaptive streaming, in which different video quality levels and attributes are assigned to different video segments, thus allowing for a higher-quality video streaming over the current broadband.

### 3. SUMMARY OF THE INVENTION

An object of the present invention is to provide an automatic parsing of digital video content that takes into account the predictable temporal structures of specific domains, corresponding unique domain-specific features, and state transition rules.

Another object of the present invention is to provide an automatic parsing of digital video content into fundamental semantic units by default or based on user's preferences.

Yet another object of the present invention is to provide an automatic parsing of digital video content based on a set of predetermined domain-specific cues.

Still another object of the present invention is to determine a set of fundamental semantic units from digital video content based on a set of predetermined domain-specific cues which represent domain-specific features corresponding to the user's choice of fundamental semantic units.

A further object of the present invention is to automatically provide indexing information for each of the fundamental semantic units.

Another object of the present invention is to integrate a set of related fundamental semantic units to form domain-specific events for browsing or navigation display.

Yet another object of the present invention is to provide content-based adaptive streaming of digital video content to one or more users.

Still another object of the present invention is to parse digital video content into one or more fundamental semantic units to which the corresponding video quality levels are assigned for transmission to one or more users based on user's preferences.

In order to meet these and other objects which will become apparent with reference to further disclosure set forth below, the present invention provides a system and method for indexing digital video content. It further provides a system and method for content-based adaptive streaming of digital video content.

In one embodiment, digital video content is parsed into a set of fundamental semantic units based on a predetermined set of domain-specific cues. The user may choose the level at which digital video content is parsed into fundamental semantic units. Otherwise, a default level at which digital video content is parsed may be set. In baseball, for example, the user may choose to see the pitches, thus setting the level of fundamental semantic units to segments of digital video content representing different pitches. The user may also choose the fundamental semantic units to represent the batters. In tennis, the user may set each fundamental semantic unit to represent one game, or even one serve. Based on the user's choice or default, the cues for determining such fundamental units are devised from the knowledge of the domain. For example, if the chosen fundamental semantic units (“FSUs”) represent pitches, the cues may be the different camera views. Conversely, if the chosen fundamental units represent batters, the cues may be the text embedded in video, such as the score board, or the announcement by the commentator. When the cues for selecting the chosen FSUs are devised, the fundamental semantic units are then determined by comparing the sets of extracted features with the predetermined cues.

In another embodiment, digital video content is automatically parsed into one or more fundamental semantic units based on a set of predetermined domain-specific cues to which the corresponding video quality levels are assigned. The FSUs with the corresponding video quality levels are then scheduled for content-based adaptive streaming to one or more users. The FSUs may be determined based on a set of extracted features that are compared with a set of predetermined domain-specific cues.

The accompanying drawings, which are incorporated and constitute part of this disclosure, illustrate an exemplary embodiment of the invention and serve to explain the principles of the invention.

### BRIEF DESCRIPTION OF THE DRAWINGS

FIG. 1 is an illustrative diagram of different levels of digital video content.

FIG. 2 is a block diagram of a system for indexing and adaptive streaming of digital video content is illustrated.

FIG. 3 is an illustrative diagram of semantic-level digital video content parsing and indexing.

FIG. 4 is a tree-logic diagram of the scene change detection.

FIGS. 5a and 5b are illustrative video frames representing an image before flashlight (a) and after (b).

FIG. 6 is a Cartesian graph representing intensity changes in a video sequence due to flashlight.

FIG. 7 is an illustrative diagram of a gradual scene change detection.

FIG. 8 is an illustrative diagram of a multi-level scene-cut detection scheme.

FIG. 9 is an illustrative diagram of the time line of digital video content in terms of inclusion f embedded text information.

FIG. 10 is an illustrative diagram of embedded text detection.

FIG. 11(a) is an exemplary video frame with embedded text.

FIG. 11(b) is another exemplary video frame with embedded text.

FIG. 12 is an illustrative diagram of embedded text recognition using template matching. 13 is an illustrative diagram of aligning of closed captions to video shots.

FIGS. 14(a)-(c) are exemplary frames presenting segmentation and detection of different objects.

FIGS. 15(a)-(b) are exemplary frames showing edge detection in the tennis court.

FIGS. 16(a)-(b) are illustrative diagrams presenting straight line detection using Hough transforms.

FIG. 17(a) is an illustrative diagram of a pitch view detection training in a baseball video.

FIG. 17(b) is an illustrative diagram of a pitch view detection in a baseball video.

FIG. 18 is a logic diagram of the pitch view validation process in a baseball video.

FIG. 19 is an exemplary set of frames representing tracking results of one serve.

FIG. 20 is an illustrative diagram of still and turning points in an object trajectory.

FIG. 21 illustrates an exemplary browsing interface for different fundamental semantic units.

FIG. 22 illustrates another exemplary browsing interface for different fundamental semantic units.

FIG. 23 illustrates yet another exemplary browsing interface for different fundamental semantic units.

FIG. 24 is an illustrative diagram of content-based adaptive video streaming.

FIG. 25 is an illustrative diagram of an exemplary content-based adaptive streaming for baseball video having pitches as fundamental semantic units.

FIG. 26 is an illustrative diagram of an exemplary content-based adaptive streaming for baseball video having batters' cycles as fundamental semantic units.

FIG. 27 is an illustrative diagram of scheduling for content-based adaptive streaming of digital video content.

### DETAILED DESCRIPTION OF THE DRAWINGS

The present invention includes a method and system for indexing and content-based adaptive streaming which may deliver higher-quality digital video content over bandwidth-limited channels.

At the beginning, definitions of three related but distinctive terms—View, Fundamental Semantic Unit (FSU), and Event—must be provided. A view refers to a specific angle and location of the camera when the video is captured. In sports video, there are a finite number of views, which have predetermined locations and angles. For example, in baseball, typical views are the views of the whole field, player close-up, ball/runner tracking, out field, etc.

FSUs are repetitive units of video data corresponding to a specific level of semantics, such as pitch, play, inning, etc. Events represent different actions in the video, such as a score, hit, serve, pitch, penalty, etc. The use of these three terms may be interchanged due to their correspondence in specific domains. For example, a view taken from behind the pitcher typically indicates the pitching event. The pitching view plus the subsequent views showing activities (e.g., motion tracking view or the out field view) constitute a FSU at the pitch-by-pitch level. A video program can be decomposed into a sequence of FSUs. Consecutive FSUs may be next to each other without time gaps, or may have additional content (e.g., videos showing crowd, commentator, or player transition) inserted in between. A FSU at a higher level (e.g., player-by-player, or inning-by-inning) may have to be based on recognition of other information such as recognition of the ball count/score by video text recognition, and the domain knowledge about the rules of the game.

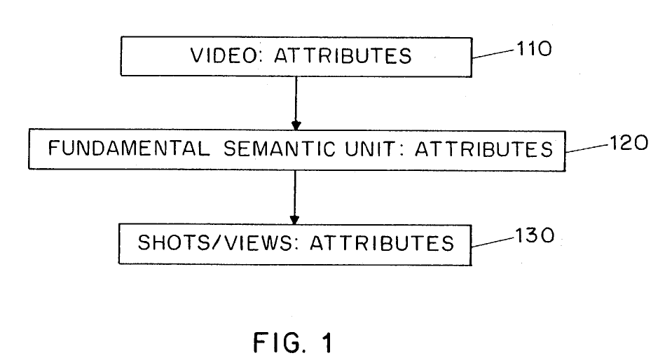

One of the aspects of the present invention is parsing of digital video content into fundamental semantic units representing certain semantic levels of that video content. Digital video content may have different semantic levels at which it may be parsed. Referring to FIG. 1, an illustrative diagram of different levels of digital video content is presented. Digital video content 110 may be automatically parsed into a sequence of Fundamental Semantic Units (FSUs) 120, which represent an intuitive level of access and summarization of the video program. For example, in several types of sports such as baseball, tennis, golf, basketball, soccer, etc., there is a fundamental level of video content which corresponds to an intuitive cycle of activity in the game. For baseball, a FSU could be the time period corresponding to a complete appearance of the batter (i.e., from the time the batter starts until the time the batter gets off the bat). For tennis, a FSU could be the time period corresponding to one game. Within each FSU, there may be multiple units of content (shots) 130 at lower levels. For example, for baseball, a batter typically receives multiple pitches. Between pitches, there may be multiple video shots corresponding to different views (e.g., close-up views of the pitcher, the batter view, runner on the base, the pitching view, and the crowd view). For tennis, a one-game FSU may include multiple serves, each of which in turn may consist of multiple views of video (close-up of the players, serving view, crowd etc).

The choice of FSU is not fixed and can be optimized based on the user preferences, application requirements and implementation constraints. For example, in the baseball video streaming system, a FSU may be the time period from the beginning of one pitch until the beginning of the next pitch. For tennis video streaming, a FSU may be the time period corresponding to one serve.

The FSUs may also contain interesting events that viewers want to access. For example, in baseball video, viewers may want to know the outcome of each batter (strike out, walk, base hit, or score). FSU should, therefore, provide a level suitable for summarization. For example, in baseball video, the time period for a batter typically is about a few minutes. A pitch period ranges from a few seconds to tens of seconds.

The FSU may represent a natural transition cycle in terms of the state of the activity. For example, the ball count in baseball resets when a new batter starts. For tennis, the ball count resets when a new game starts. The FSUs usually start or end with special cues. Such cues could be found in different domains. For example, in baseball such cues may be new players walking on/off the bat (with introduction text box shown on the screen) and a relatively long time interval between pitching views of baseball. Such special cues are used in detecting the FSU boundaries.

Another important source of information is the state transition rules specific to each type of video. For example, in baseball, the state of the game must follow certain predetermined rules. The ball count starts at 0-0 with an increment of 1 strike or 1 ball up to 3-2. The maximum of three outs are allowed in each inning. Such rules are well established in many domains and can be incorporated to help develop automatic tools to parse the video and recognize the state of the game or improve the performance of video text recognition.

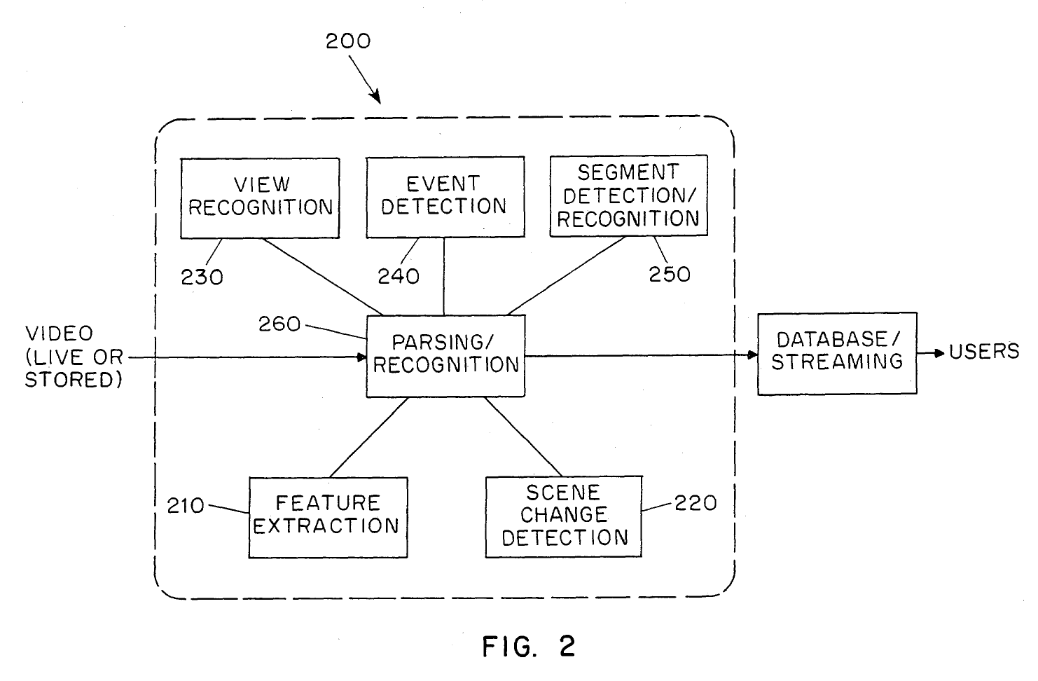

Referring to FIG. 2, a block diagram with different elements of a method and system for indexing and adaptive streaming of digital video content 200 is illustrated. When digital video content is received, a set of features is extracted by a feature extraction module 210 based on a predetermined set of domain-specific and state-transition-specific cues. The pre-determined cues may be derived from domain knowledge and state transition. The set of features that may be extracted include scene changes, which are detected by a scene change detection module 220. Using the results from Feature Extraction module 210 and Scene Change Detection module 220, different views and events are recognized by a View Recognition module 230 and Event Detection module 240, respectively. Based on users' preferences and the results obtained from different modules, one or more segments are detected and recognized by a Segments Detection/Recognition Module 250, and digital video content is parsed into one or more fundamental semantic units representing the recognized segments by a parsing module 260. For each of the fundamental semantic units, the corresponding attributes are determined, which are used for indexing of digital video content. Subsequently, the fundamental semantic units representing the parsed digital video content and the corresponding attributes may be streamed to users or stored in a database for browsing.

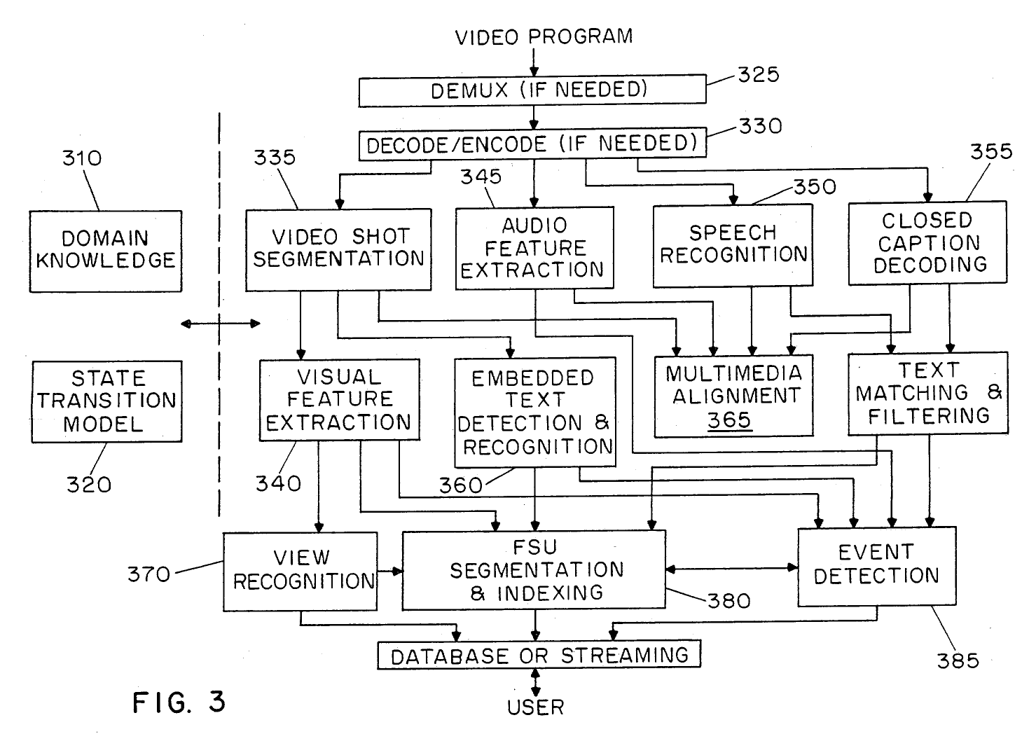

Referring to FIG. 3, an illustrative functional diagram of automatic video parsing and indexing system at the semantic level is provided. As discussed, digital video content is parsed into a set of fundamental semantic units based on a predetermined set of domain-specific cues and state transition rules. The user may choose the level at which digital video content is parsed into fundamental semantic units. Otherwise, a default level at which digital video content is parsed may be set. In baseball, for example, the user may choose to see the pitches, thus setting the level of fundamental semantic units to segments of digital video content representing different pitches. The user may also choose the fundamental semantic units to represent the batters. In tennis, the user may set each fundamental semantic unit to represent one game, or even one serve.

Based on the user's choice or default, the cues for determining such fundamental units are devised from the domain knowledge 310 and the state transition model 320. For example, if the chosen fundamental semantic units represent pitches, the cues may be the different camera views. Conversely, if the chosen fundamental units represent batters, the cues may be the text embedded in video, such as the score board, or the announcement by the commentator.

Different cues, and consequently, different features may be used for determining FSUs at different levels. For example, detection of FSUs at the pitch level in baseball or the serve level in tennis is done by recognizing the unique views corresponding to pitching/serving and detecting the follow-up activity views. Visual features and object layout in the video may be matched to detect the unique views. Automatic detection of FSUs at a higher level may be done by combining the recognized graphic text from the images, the associated speech signal, and the associated closed caption data. For example, the beginning of a new FSU at the batter-by-batter level is determined by detecting the reset of the ball count text to 0-0 and the display of the introduction information for the new batter. In addition, an announcement of a new batter also may be detected by speech recognition modules and closed caption data.

At even higher levels, e.g., innings or sets, automatic detection of FSUs can be done by detecting commercial breaks, recognizing the scoreboard text on the screen, or detecting relevant information in the commentator's speech. When the cues for selecting the chosen FSUs are devised, the fundamental semantic units are then determined by comparing the sets of extracted features with the predetermined cues. In order to successfully parse digital video content into fundamental semantic units based on a predetermined set of cues corresponding to certain domain-specific features, the system has various components, which are described in more detail below.

A Domain Knowledge module 310 stores information about specific domains. It includes information about the domain type (e.g., baseball or tennis), FSU, special editing effects used in the domain, and other information derived from application characteristics that are useful in various components of the system.

Similarly, a State Transition Model 320 describes the temporal transition rules of FSUs and video views/shots at the syntactic and semantic levels. For example, for baseball, the state of the game may include the game scores, inning, number of out, base status, and ball counts. The state transition model 320 reflects the rules of the game and constrains the transition of the game states. At the syntactic level, special editing rules are used in producing the video in each specific domain. For example, the pitch view is usually followed by a close-up view of the pitcher (or batter) or by a view tracking the ball (if it is a hit). Conceptually, the State Transition Model 320 captures special knowledge about specific domains; therefore, it can also be considered as a sub-component of the Domain Knowledge Module 310.

A Demux (demultiplexing) module 325 splits a video program into constituent audio, video, and text streams if the input digital video content is a multiplexed stream. For example, a MPEG-1 stream can be split into elementary compressed video stream, elementary audio compressed stream, and associated text information. Similarly, a Decode/Encode module 330 may decode each elementary compressed stream into uncompressed formats that are suitable for subsequent processing and analysis. If the subsequent analysis modules operate in the compressed format, the Decode/Encode module 330 is not needed. Conversely, if the input digital video content is in the uncompressed format and the analysis tool operates in the compressed format, the Encode module is needed to convert the stream to the compressed format.

A Video Shot Segmentation module 335 separates a video sequence into separate shots, each of which usually includes video data captured by a particular camera view. Transition among video shots may be due to abrupt camera view change, fast camera view movement (like fast panning), or special editing effects (like dissolve, fade). Automatic video shot segmentation may be obtained based on the motion, color features extracted from the compressed format and the domain-specific models derived from the domain knowledge.

Video shot segmentation is the most commonly used method for segmenting an image sequence into coherent units for video indexing. This process is often referred to as a “Scene change detection.” Note that “shot segmentation” and “scene change detection” refer to the same process. Strictly speaking, a scene refers to a location where video is captured or events take place. A scene may consist of multiple consecutive shots. Since there are many different changes in video (e.g. object motion, lighting change and camera motion), it is a nontrivial task to detect scene changes. Furthermore, the cinematic techniques used between scenes, such as dissolves, fades and wipes, produce gradual scene changes that are harder to detect.

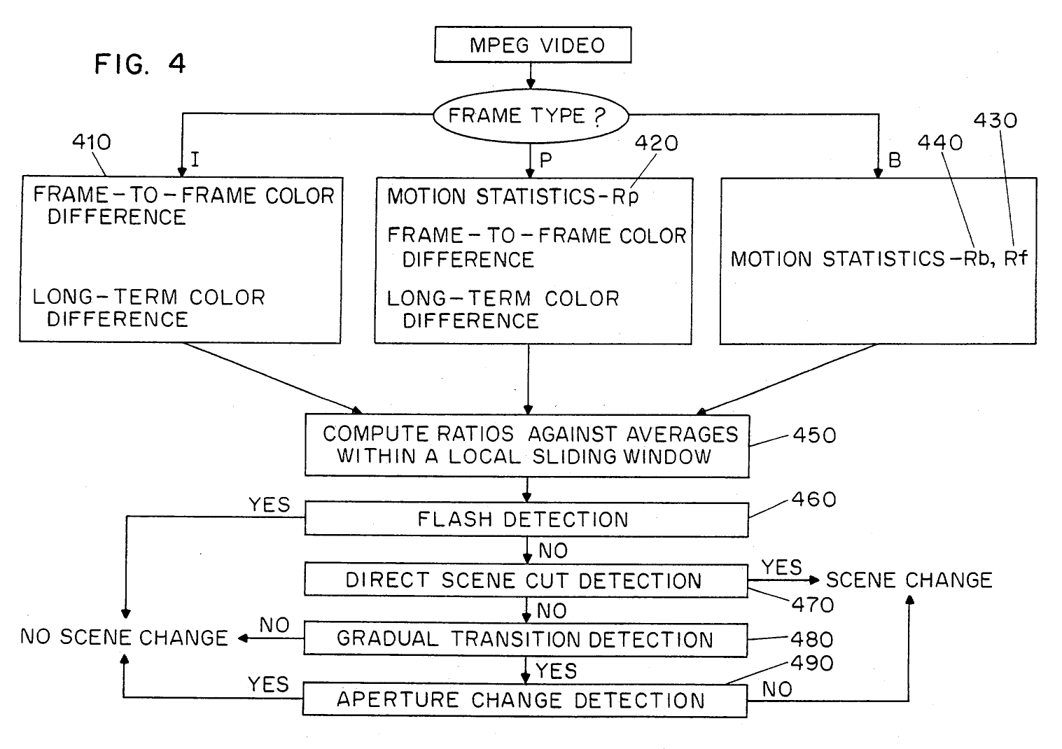

An algorithm for detecting scene changes has been previously disclosed in J. Meng and S.-F. Chang, Tools for Compressed-Domain Video Indexing and Editing, SPIE Conference on Storage and Retrieval for Image and Video Database, San Jose, February 1996, the contents of which are incorporated herewith by reference. The method for detecting scene changes of the present invention is based on an extension and modification of that algorithm. This method combines motion and color information to detect direct and gradual scene changes. An illustrative diagram of scene change detection is shown in FIG. 4.

The method for scene change detection examines an MPEG video content frame by frame to detect scene changes. MPEG video may have different frame types, such as intra- (I-) and non-intra (B- and P-) frames. Intra-frames are processed on a spatial basis, relative only to information within the current video frame. P-frames represent forward interpolated prediction frames. P-frames are predicted from the frame immediately preceding it, whether it be an I frame or a P frame. Therefore, these frames also have a temporal basis. B-frames are bi-directional interpolated prediction frames, which are predicted both from the preceding and succeeding I- or P-frames.

Referring to FIG. 4, the color and motion measures are first computed. For an I-type frame, the frame-to-frame and long-term color differences 410 are computed. The color difference between two frames i and j is computed in the LUV space, where L represents the luminance dimension while U and V represent the chrominance dimensions. The color difference is defined as follows:

D(i,j)=|\overline{Y}ᵢ−\overline{Y}ⱼ|+|σ_{Y}ⁱ−σ_{Y}^{j}|+W^{•}(|\overline{U}ⱼ−\overline{U}ⱼ|+σ_{U}ⁱ−σ_{U}^{j}|+|\overline{V}ᵢ−\overline{V}ⱼ|+|σ_{V}ⁱ−σ_{V}^{j}|) (1)

where \overline{Y}, \overline{U}, \overline{V} are the average L, U and V values computed from the DC images of frame i and j, σ_{Y}, σ_{U}, σ_{V} are the corresponding standard deviations of the L, U and V channels; w is the weight on chrominance channels U and V. When i−j=1, D(i,j) is the frame-to-frame color difference; when i−j=k and k>1, D(i,j) is the k-long-term color difference.

For a P-type frame, its DC image is interpolated from its previous I or P frame based on the forward motion vectors. The computation of color differences are the same as for I-type frame. For P-type frames, the ratio of the number of intra-coded blocks to the number of forward motion vectors in the P-frame Rp 420 is computed. Detailed description of how this is computed can be found in J. Meng and S.-F. Chang, Tools for Compressed-Domain Video Indexing and Editing, SPIE Conference on Storage and Retrieval for Image and Video Database, San Jose, February 1996.

For a B-type frame, the ratio of the number of forward motion vectors to the number of backward motion vectors in the B-frame Rf 430 is computed. Furthermore, the ratio of the number of backward motion vectors to the number of forward motion vectors in the B-frame Rb 440 is also computed.

Instead of setting a global threshold, an adaptive local window 450 to detect peak values that indicate possible scene changes may also be used. Each measure mentioned above is normalized by computing the ratio of the measure value to the average value of the measure in a local sliding window. For example, the frame-to-frame color difference ratio refers to the ratio of the frame-to-frame color difference (described above) to the average value of such measure in a local window.

After all the measures and ratios are computed, the algorithm enters the detection stage. The first step is flash detection 460. Flashlights occur frequently in home videos (e.g. ceremonies) and news programs (e.g. news conferences). They cause abrupt brightness changes of a scene and are detected as false scene changes if not handled properly. A flash detection module (not shown) before the scene change detection process is applied. If flashlight is detected, the scene change detection is skipped for the flashing period. If the scene change happens at the same time as flashlight, flashlight is not mistaken for a scene change, whereas the scene change coinciding with the flashlight gets detected correctly.

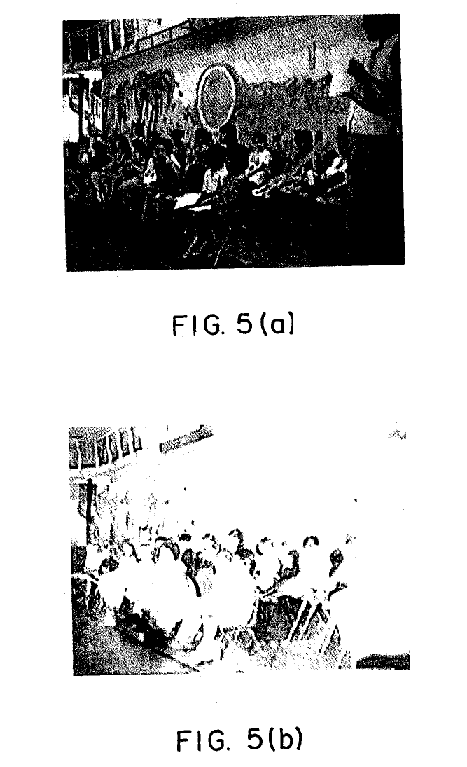

Flashlights usually last less than 0.02 second. Therefore, for normal videos with 25 to 30 frames per second, one flashlight affect sat most one frame. A flashlight example is illustrated in FIGS. 5a and 5b. Referring to FIG. 5b, it is obvious that the affected frame has very high brightness, and it can be easily recognized.

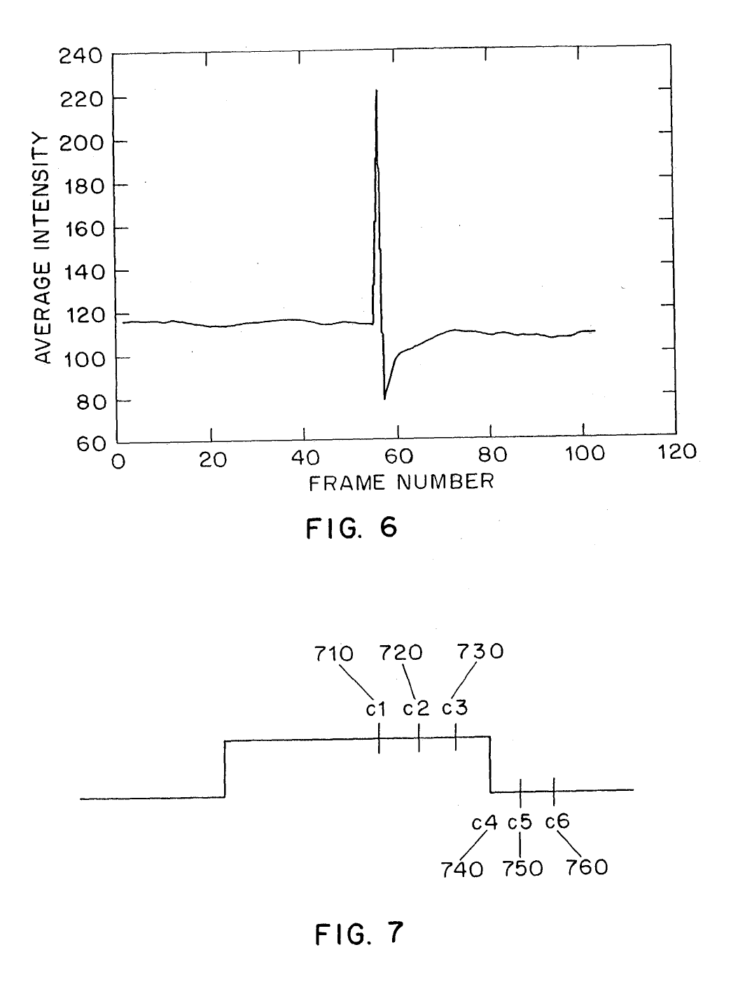

Flashlights may cause several changes in a recorded video sequence. First, they may generate a bright frame. Note that since the frame interval is longer than the time of flashlights, flashlight does not always generate the bright frame. Secondly, flashlights often cause the aperture change of a video camera, and generates a few dark frames in the sequence right after the flashlight. The average intensities over the flashlight period in the above example are shown in FIG. 6.

Referring to FIG. 6, a Cartesian graph illustrating typical intensity changes in a video sequence due to flashlight is illustrated. The intensity jumps to a high level at the frame where the flashlight occurs. The intensity goes back to normal after a few frames (e.g., 4 to 8 frames) due to aperture change of video cameras. Conversely, for a real scene change, the intensity (or color) distribution will not go back to the original level. Based on this feature, the ratio of the frame-to-frame color difference and the long-term color differences may be used to detect flashes. The ratio is defined as follows:

Fr(i)=D(i,i−1)/D(i+δ,i−1), (2)

where i is the current frame, and δ is the average length of aperture change of a video camera (e.g. 5). If the ratio Fr(i) is higher than a given threshold (e.g. 2), a flashlight is detected at the frame i.

Obviously, if the long term color difference is used at frame i+δ to detect flashlight at frame i, this will become a non-causal system. In actual implementation, we need to introduce a latency not less than δ in the detection process. Also, in order to determine the threshold value, we use a local window centered at the frame being examined to adaptively set thresholds.

Note that the above flash detection algorithm only applies to I- and P-frames, as color features are not extracted with respect to B-frames. However, a flashlight occurring at a B-type frame (i.e. bi-direction projected frame) does not cause any problem in the scene change detection algorithm because a flashed frame is almost equally different from its former and successive frames, and thus forward and backward motion vectors are equally affected.

When a scene change occurs at or right after the flashlight frame, the flashlight is not detected be detected because the long-term color difference is also large due to the scene cut. As the goal is to detect actual scene changes, misses of flashlights are acceptable.

The second detection step is a direct scene changes detection 470. For an I-frame, if the frame-to-frame color difference ratio is larger than a given threshold, the frame is detected as a scene change. For a P-frame, if the frame-to-frame color difference ratio is larger than a given threshold, or the Rp ratio is larger than a given threshold, it is detected as a scene change. For a B-frame, if the Rf ratio is larger than a threshold, the following I or P frame (in display order) is detected as a scene change; if the Rb ratio is larger than a threshold, the current B-frame is detected as a scene change.

If no direct scene change is detected, the third step, a gradual transitions detection 480, is taken. Referring to FIG. 7, a detection of the ending point of a gradual scene change transition is illustrated. This approach uses color difference ratios, and is applied only on I and P frames.

Here c1-c6 are the frame-to-frame color difference ratios on I or P frames. If c1 710, c2 720 and c3 730 are larger than a threshold, and c4 740, c5 750 and c6 760 are smaller than another threshold, a gradual scene change is said to end at frame c4.

The fourth step is an aperture change detection 490. The camera aperture changes frequently occur in home videos. It causes gradual intensity change over a period of time and may be falsely detected as a gradual scene change. To solve this problem, a post detection process is applied, which compares the current detected scene change frame with the previous scene change frame based on their chrominaces and edge direction histogram. If the difference is smaller than a threshold, the current gradual scene change is ignored (i.e., considered as a false change due to camera aperture change).

Many determinations described above are made based on the use of various threshold values. One way of obtaining such threshold values may be by using training data. Another way may be to apply machine learning algorithms to automatically determine the optimal values for such thresholds.

In order to automatically determine the optimal threshold values used in various components in the scene change detection module, a decision tree may be developed using the measures (e.g., color difference ratios and motion vector ratios) as input and classifying each frame into distinctive classes (i.e., scene change vs. no scene change). The decision tree uses different measures at different levels of the tree to make intermediate decisions and finally make a global decision at the root of the tree. In each node of the tree, intermediate decisions are made based on some comparisons of combinations of the input measures. It also provides optimal values of the thresholds used at each level.

Users can also manually add scene changes in real time when the video is being parsed. If a user is monitoring the scene change detection process and notices a miss or false detection, he or she can hit a key or click mouse to insert or remove a scene change in real time.

Although a decision tree may be used to determine optimized threshold values from a large training video set, there may be false alarms or misses associated with the indexing process. A browsing interface may be used for users to identify and correct false alarms. For errors of missing correct scene changes, users may use the interactive interface during real-time playback of video to add scene changes to the results.

To solve the problem of false alarms, a multi-level scheme for detecting scene changes may be designed. In this scheme, additional sets of thresholds with lower values may be used in addition to the optimized threshold values. Scene changes are then detected at different levels.

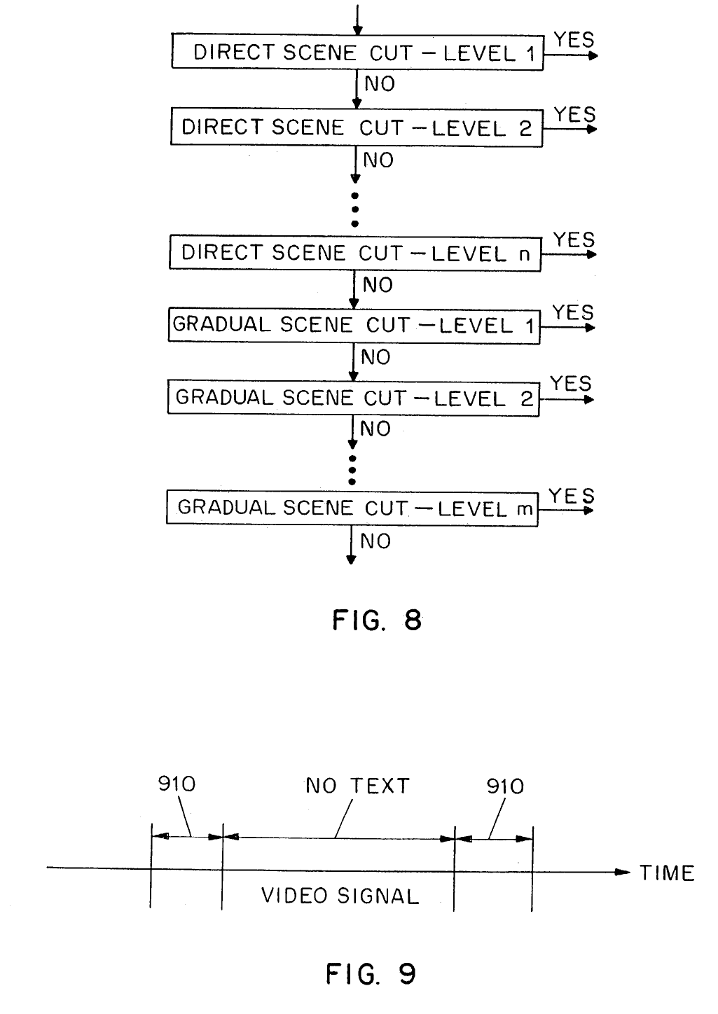

Referring to FIG. 8, an illustrative diagram of the multi-level scene change detection is illustrated. Threshold values used in level i are lower than those used in level j if i>j. In other words, more scene changes are detected at level j. As shown in FIG. 8, the detection process goes from the level with higher thresholds to the level with lower thresholds. In other words, it first detects direct scene changes, then gradual scene changes. The detection process stops whenever a scene change is detected or the last level is reached. The output of this method includes the detected scene changes at each level. Obviously, scene changes found at one level are also scene changes at the levels with lower thresholds. Therefore, a natural way of reporting such multi-level scene change detection results is like the one in which the numbers of detected scene changes are listed for each level. The numbers for the higher level represent the numbers of additional scene changes detected when lower threshold values are used.

In a preferred embodiment, more levels for the gradual scene change detection are used. Gradual scene changes, such as dissolve and fade, are likely to be confused with fast camera panning/zooming, motion of large objects and lighting variation. A high threshold will miss scene transitions, while a low threshold may produce too many false alarms. The multi-level approach generates a hierarchy of scene changes. Users can quickly go through the hierarchy to see positive and negative errors at different levels, and then make corrections when needed.

Returning to FIG. 3, a Visual Feature Extraction Module 340 extracts visual features that can be used for view recognition or event detection. Examples of visual features include camera motions, object motions, color, edge, etc.

An Audio Feature Extraction module 345 extracts audio features that are used in later stages such as event detection. The module processes the audio signal in compressed or uncompressed formats. Typical audio features include energy, zero-crossing rate, spectral harmonic features, cepstral features, etc.

A Speech Recognition module 350 converts a speech signal to text data. If training data in the specific domain is available, machine learning tools can be used to improve the speech recognition performance.

A Closed Caption Decoding module 355 decodes the closed caption information from the closed caption signal embedded in video data (such as NTSC or PAL analog broadcast signals).

An Embedded Text Detection and Recognition Module 360 detects the image areas in the video that contain text information. For example, game status and scores, names and information about people shown in the video may be detected by this module. When suitable, this module may also convert the detected images representing text into the recognized text information. The accuracy of this module depends on the resolution and quality of the video signal, and the appearance of the embedded text (e.g., font, size, transparency factor, and location). Domain knowledge 310 also provides significant help in increasing the accuracy of this module.

The Embedded Text Detection and Recognition module 360 aims to detect the image areas in the video that contain text information, and then convert the detected images into text information. It takes advantage of the compressed-domain approach to achieve real-time performance and uses the domain knowledge to improve accuracy.

The Embedded Text Detection and Recognition method has two parts—it first detects spatially and temporally the graphic text in the video; and then recognizes such text. With respect to spatial and temporal detection of the graphic text in the video; the module detects the video frames and the location within the frames that contain embedded text. Temporal location, as illustrated in FIG. 9, refers to the time interval of text appearance 910 while the spatial location refers to the location on the screen. With respect to text recognition, it may be carried out by identifying individual characters in the located graphic text.

Text in video can be broadly broken down in two classes: scene text and graphic text. Scene text refers to the text that appears because the scene that is being filmed contains text. Graphic text refers to the text that is superimposed on the video in the editing process. The Embedded Text Detection and Recognition 360 recognizes graphic text. The process of detecting and recognizing graphic text may have several steps.

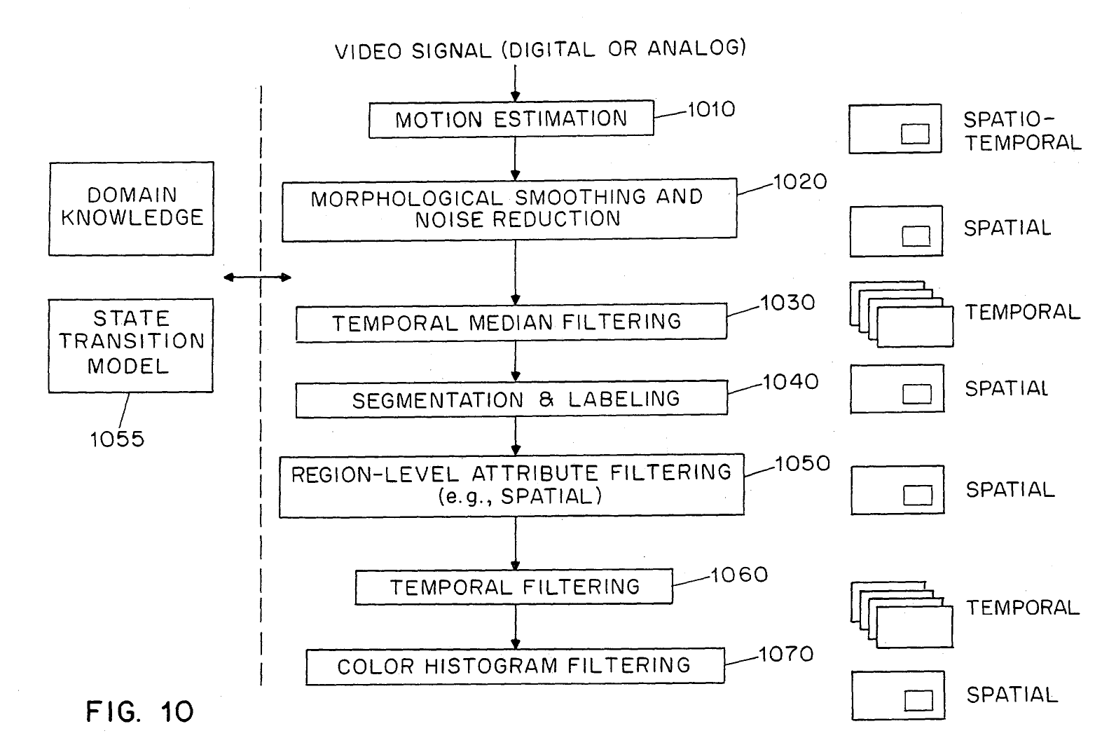

Referring to FIG. 10, an illustrative diagram representing the embedded text detection method is shown. There are several steps which are followed in this exemplary method.

First, the areas on the screen that show no change from frame-to-frame or very little change relative to the amount of change in the rest of the screen are located by motion estimation module 1010. Usually, the screen is broken into small blocks (for example, 8 pixels×8 pixels or 16 pixels×16 pixels), and candidate blocks are identified. If the video is compressed, this information can be inferred by looking at the motion-vectors of Macro-Blocks. Detect zero-value motion vectors may be used for detecting such candidate blocks. This technique takes advantage of the fact that superimposed text is completely still and therefore text-areas change very little from frame to frame. Even when non-text areas in the video are perceived by humans to be still, there is some change when measured by a computer. However, this measured change is essentially zero for graphic text.

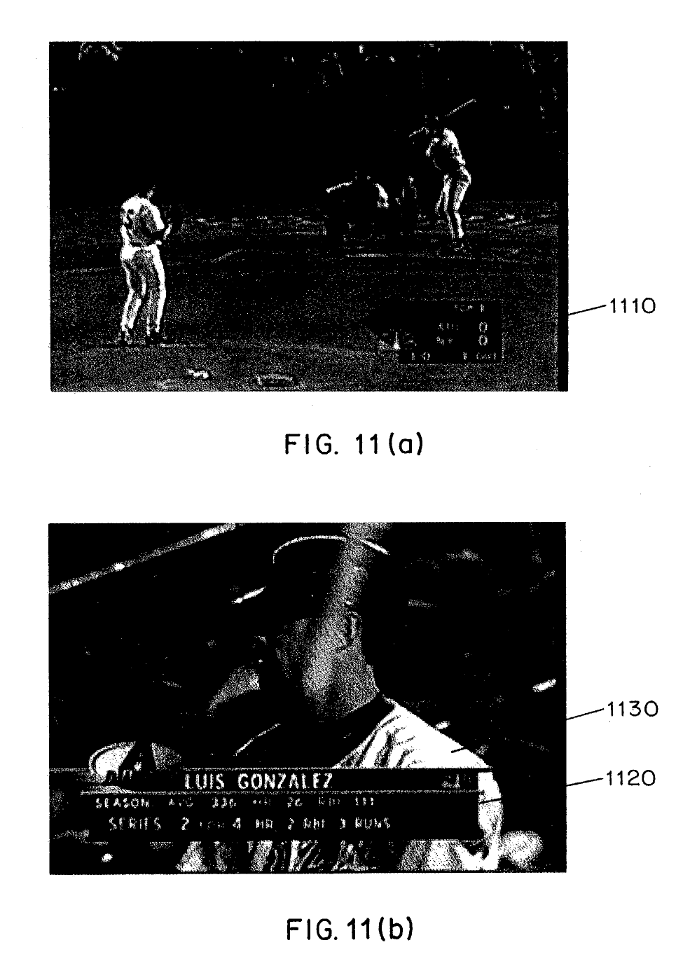

In practice, however, graphic text can have varying opacity. A highly opaque text-box does not show through any background, while a less opaque text-box allows the background to be seen. Non-opaque text-boxes therefore show some change from frame-to-frame, but that change measured by a computer still tends to be small relative to the change in the areas surrounding the text, and can therefore be used to extract non-opaque text-boxes. Two examples of graphic text with differing opacity are presented in FIGS. 11(a) and 11(b). FIG. 11(a) illustrates a text box 1110 which is highly opaque, and the background cannot be seen through it. FIG. 11(b) illustrates a non-opaque textbox 1120 through which the player's jersey 1130 may be seen.

Second, noise may be eliminated and spatially contiguous areas may be identified, since text-boxes ordinarily appear as contiguous areas. This is accomplished by using a morphological smoothing and noise reduction module 1020. After the detection of candidate areas, the morphological operations such as open and close are used to retain only contiguous clusters.

Third, temporal median filtering 1030 is applied to remove spurious detection errors from the above steps.

Fourth, the contiguous clusters are segmented into different candidate areas and labeled by a segmentation and labeling module 1040. A standard segmentation algorithm may be used to segment and label the different clusters.

Fifth, spatial constraints may be applied by using a region-level Attribute Filtering module 1050. Clusters that are too small, too big, not rectangular, or not located in the required parts of the image may be eliminated. For example, the ball-pitch text-box in a baseball video is relatively small and appears only in one of the corners, while a text-box introducing a new player is almost as wide as the screen, and typically appears in the bottom half of the screen.

Sixth, state-transition information from state transition model 1055 is used for temporal filtering and merging by temporal filtering module 1060. If some knowledge about the state-transition of the text in the video exists, it can be used to eliminate spurious detection and merge incorrectly split detection. For example, if most appearances of text-boxes last for a period of about 7 seconds, and they are spaced at least thirty seconds apart, two text boxes of three seconds each with a gap of one second in between can be merged. Likewise, if a box is detected for a second, ten seconds after the previous detection, it can be eliminated as spurious. Other information like the fact that text boxes need to appear for at least 5 seconds or 150 frames for humans to be able to read them can be used to eliminate spurious detection that last for significantly shorter periods.

Seventh, spurious text-boxes are eliminated by applying a color-histogram filtering module 1070. Text-boxes tend to have different color-histograms than natural scenes, as they are typically bright-letters on a dark background or dark-letters on a bright background. This tends to make the color histogram values of text areas significantly different from surrounding areas. The candidate areas may be converted into the HSV color-space, and thresholds may be used on the mean and variance of the color values to eliminate spurious text-boxes that may have crept in.

Once the graphic text is spatially and temporally detected in the video, it may be recognized. Text recognition may be carried out based on the resolution of characters, i.e. individual characters (or numerals) may be identified in the text box detected by the process described above. The size of the graphic text is first determined, then the potential locations of characters in the text box are determined, statistical templates, which are previously created are sized according to the detected font size, and finally the characters are compared to the templates, recognized, and associated with their locations in the text box.

Text font size in a text-box is determined by comparing a text-box from one frame to its previous frame (either the immediately previous frame in time or the last frame of the previous video segment containing a text-box). Since the only areas that change within a particular text-box are the specific texts of interest, computing the difference between a particular text-box as it appears on different frames, tells us the dimension of the text used (e.g., n pixels wide and m pixels high;). For example, in baseball video, only a few characters in the ball-pitch text box are changed every time it is updated.

The location of potential characters within a text-box is identified by locating peaks and dips in the brightness (value) within the text-box. This is due to the fact that most text boxes have bright text over dark background or vice versa.

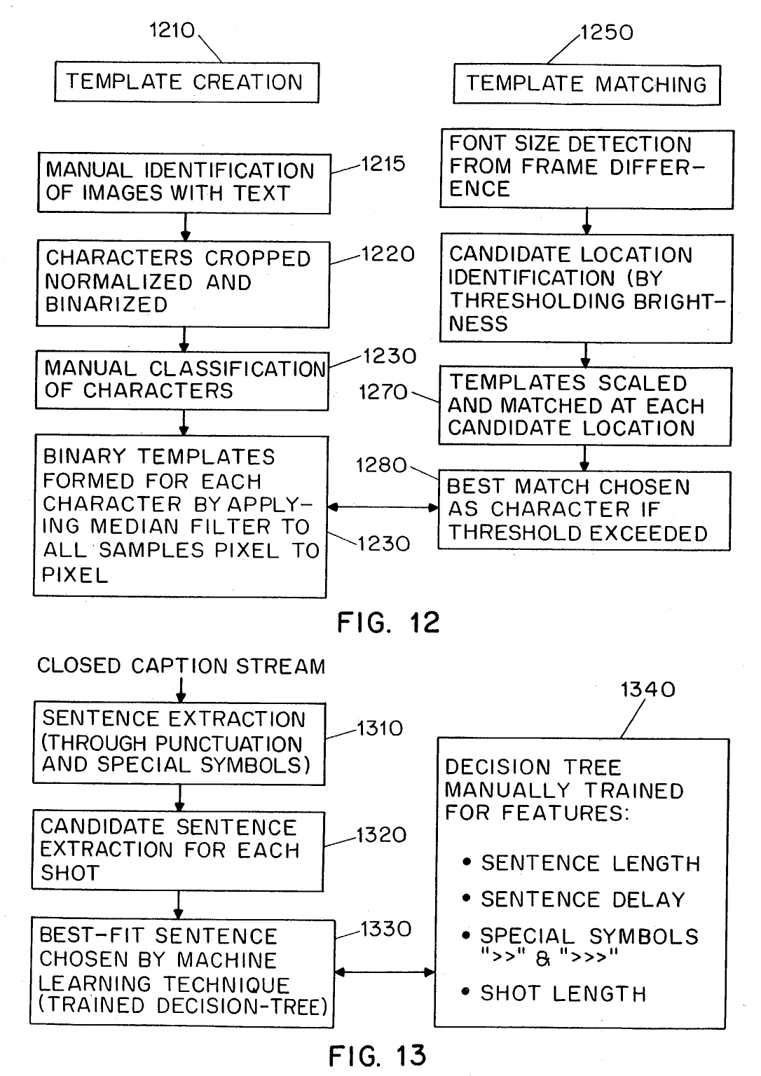

As shown in FIG. 12, a statistical template 1210 may be created in advance for each character by collecting video samples of such character. Candidate locations for characters within a text-box area are identified by looking at a coarsely sub-sampled view of the text-area. For each such location, the template that matches best is identified. If the fit is above a certain bound, the location is determined to be the character associated with the template.

The statistical templates may be created by following several steps. For example, a set of images with text may be manually extracted from the training video sequences 1215. The position and location of individual characters and numerals are identified in these images. Furthermore, sample characters are collected. Each character identified in the previous step is cropped, normalized, binarized, and labeled in a cropping module 1220 according to the character it represents. Finally, for each character, a binary template is formed in a binary templates module 1230 by taking the median value of all its samples, pixel by pixel.

Character templates created in advance are then scaled appropriately and matched by using template matching 1270 to the text-box at the locations identified in the previous step. A pixel-wise XOR operation is used to compute the match. Finally, the character associated with the template that has the best match is associated with a location if it is above a preset threshold 1280. Note that the last two steps described above can be replaced by other character recognition algorithms, such as neural network based techniques or nearest neighbor techniques.

Returning again to FIG. 3, a Multimedia Alignment module 365 is used to synchronize the timing information among streams in different media. In particular, it addresses delays between the closed captions and the audio/video signals. One method of addressing such delays is to collect experimental data of the delays as training data and then apply machine learning tools in aligning caption text boundaries to the correct video shot boundaries. Another method is to synchronize the closed caption data with the transcripts from speech recognition by exploring their correlation.

One method of providing a synopsis of a video is to produce a storyboard: a sequence of frames from the video, optionally with text, chronologically arranged to represent the key events in the video. A common automated method for creating storyboards is to break the video into shots, and to pick a frame from each shot. Such a storyboard, however, is vastly enriched if text pertinent to each shot is also provided.

One typical solution may be obtained by looking at closed captions, which are often available with videos. As shown in FIG. 13, the closed-caption text is broken up into sentences 1310 by observing punctuation marks and the special symbols used in closed-captioning. One key issue in using such closed captions is determining the right sentences that can be used to describe each shot. This is commonly referred to as the alignment problem.

Machine-learning techniques may be used to identify a sentence from the closed-caption that is most likely to describe a shot. The special symbols associated with the closed caption streams that indicate a new speaker or a new story are used where available. Different criteria are developed for different classes of videos such as news, talk shows or sitcoms.

Such a technique is necessary because closed-caption streams are not closely synchronized with their video streams. Usually, there is some latency between a video stream and its closed-caption stream, but this latency varies depending on whether the closed-captions were added live or after the filming.

Referring to FIG. 13, an illustrative diagram of aligning closed captions to video shots is shown. The closed caption stream associated with a video is extracted along with punctuation marks and special symbols. The special symbols are, for example, “ [symbol] ” identifying a new speaker and “ [symbol] >” identifying a new story. The closed caption stream is then broken up into sentences 1310 by recognizing punctuation marks that mark the end of sentences such as “.”, “?” and “!”. For each shot boundary, all potential sentences that may best explain the following shot are collected 1320. All complete sentences that begin within an interval surrounding the shot boundary—say ten seconds on either side—and end within the shot are considered candidates. The sentence, among these, that best corresponds to the shot following the boundary is chosen by comparing it to a decision-tree generated for this class of videos 1330. This takes into account any inherent latency in this class of videos. A decision-tree may be used in the above step. The decision tree 1340 may be created based on the following features: latency of beginning of sentence from beginning of shot, length of sentence, length of shot, whether it is the beginning of the story (sentence began with symbol >>>), or whether the story is spoken by a new speaker (sentence began with symbol >>). For each class of video, a decision-tree is trained. For each shot, the user chooses among the candidate sentences. Using this training information, the decision-tree algorithm orders features by their ability to choose the correct sentence. Then, when asked to pick the sentence that may best correspond to a shot, the decision-tree algorithm may use this discriminatory ability to make the choice.

Returning to FIG. 3, View Recognition module 370 recognizes particular camera views in specific domains. For example, in baseball video, important views include the pitch view, whole field view, close-up view of players, base runner view, and crowd view. Important cues of each view can be derived by training or using specific models.

Also, broadcast videos usually have certain domain-specific scene transition models and contain some unique segments. For example, in a news program anchor persons always appear before each story; in a baseball game each pitch starts with the pitch view; and in a tennis game the full court view is shown after the ball is served. Furthermore, in broadcast videos, there are ordinarily a fixed number of cameras covering the events, which provide unique segments in the video. For example, in football, a game contains two halves, and each half has two quarters. In each quarter, there are many plays, and each play starts with the formation in which players line up on two sides of the ball. A tennis game is divided first into sets, then games and serves In addition, there may be commercials or other special information inserted between video segments, such as players' names, score boards etc. This provides an opportunity to detect and recognize such video segments based on a set of predetermined cues provided for each domain through training.

Each of those segments are marked at the beginning and at the end with special cues. For example, commercials, embedded texts and special logos may appear at the end or at the beginning of each segment. Moreover, certain segments may have special camera views that are used, such as pitching views in baseball or serving views of the full court in tennis. Such views may indicate the boundaries of high-level structures such as pitches, serves etc.

These boundaries of higher-level structures are then detected based on predetermined, domain-specific cues such as color, motion and object layout. As an example of how such boundaries are detected, a video content representing a tennis match in which serves are to be detected is used below.

A fast adaptive color filtering method to select possible candidates may be used first, followed by segmentation-based and edge-based verifications.

Color based filtering is applied to key frames of video shots. First, the filtering models are built through a clustering based training process. The training data should provide enough domain knowledge so that a new video content may be similar to some in the training set. Assuming hᵢ, i=1 . . . , N are color histograms of all serve scenes in the training set for tennis domain. A k-means clustering is used to generate K models (i.e., clusters), M₁, . . . , M_{K}, such that:

$${h}_{i} ∈ {M}_{j} , if D ( {h}_{i} , {M}_{j} ) = {{min}_{k = 1}}^{K} ( D ( {h}_{i} , {M}_{k} ) ) , \qquad ( 3 )$$

where D(hᵢ, Mₖ) is the distance between hᵢ and the mean vector of Mₖ, i.e.

$${H}_{k} = \frac{1}{\vert {M}_{k} \vert} {\sum }_{{h}_{i} ∈ {M}_{k}} {h}_{i}$$

and |Mₖ| is the number of training scenes being classified into the model Mₖ. This means that for each module Mₖ, Hₖ is used as its the representative feature vector.

When a new game starts, proper models are chosen to spot serve scenes. Initially, the first L serve scenes are detected using all models, M₁, . . . , M_{K}, in other words, all models are used in the filtering process. If one scene is close enough to any model, the scene will be passed through to subsequent verification processes:

$${h}_{i}^{′} ∈ {M}_{j} , if D ( {h}_{i}^{′} , {M}_{j} ) = {{min}_{k = 1}}^{K} ( D ( {h}_{i}^{′} , {M}_{k} ) ) \\ and D ( {h}_{i}^{′} , {M}_{j} ) < TH , \qquad ( 4 )$$

where h′ᵢ is the color histogram of the i-th shot in the new video, and TH is a given filtering threshold for accepting shots with enough color similarity. Once shot i is detected as a potential serve scene, it is subjected to a segmentation based verification.

After L serve scenes are detected, the model Mₒ may be chosen, which leads to the search for the model with the most serve scenes:

$$\vert {M}_{o} \vert = {{max}_{k = 1}}^{K} ( \vert {M}_{k} \vert ) \qquad ( 5 )$$

where |Mₖ| is the number of incoming scenes being classified into the model

The adaptive filtering deals with global features such as color histograms. However, it also may be possible to use spatial-temporal features, which are more reliable and invariant. Certain special scenes, such as in sports videos, often have several objects at fixed locations. Furthermore, the moving objects are often localized in one part of a particular set of key frames. Hence, the salient feature region extraction and moving object detection may be utilized to determine local spatial-temporal features. The similarity matching scheme of visual and structure features also can be easily adapted for model verification.

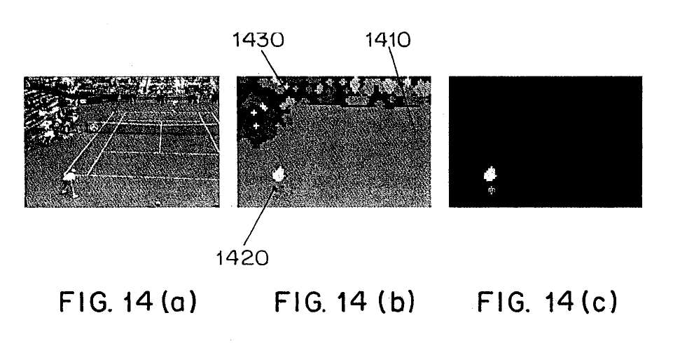

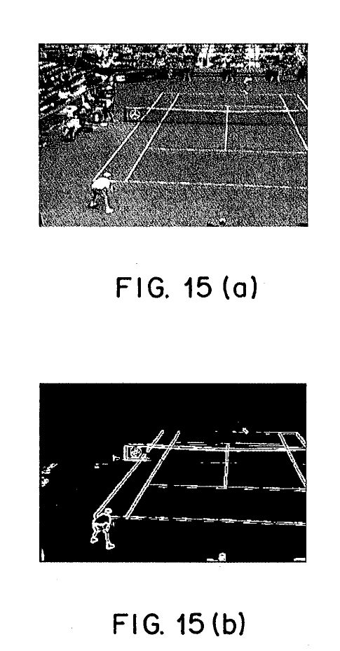

When real-time performance is needed, segmentation may be performed on the down-sampled images of the key frame (which is chosen to be an I-frame) and its successive P-frame. The down-sampling rate may range approximately from 16 to 4, both horizontally and vertically. An example of segmentation and detection results is shown in FIGS. 14(a)-(c).

FIG. 14(b) shows a salient feature region extraction result. The court 1410 is segmented out as one large region, while the player 1420 closer to the camera is also extracted. The court lines are not preserved due to the down-sampling. Black areas 1430 shown in FIG. 14(b) are tiny regions being dropped at the end of segmentation process.

FIG. 14(c) shows the moving object detection result. In this example, only the desired player 1420 is detected. Sometimes a few background regions may also be detected as foreground moving object, but for verification purpose the important thing is not to miss the player.

The following rules are applied in this exemplary scene verification. First, there must be a large region (e.g. larger than two-thirds of the frame size) with consistent color (or intensity for simplicity). This large region corresponds to the tennis court. The uniformity of a region is measured by the intensity variance of all pixels within the region:

$$Var ( p ) = \frac{1}{N} {\sum }_{i = 1}^{N} {[ I ( {p}_{i} ) - \overline{I} ( p ) ]}^{2} \qquad ( 6 )$$

where N is the number of pixels within a region p, I(pᵢ) is the intensity of pixel I and \overline{I}(p) is the average intensity of region p. If Var(p) is less than a given threshold, the size of region p is examined to decide if it corresponds to the tennis court.

Second, the size and position of player are examined. The condition is satisfied if a moving object with proper size is detected within the lower half part of the previously detected large “court” region. In a downsized 88×60 image, the size of a player is usually between 50 to 200 pixels. As the detection method is applied at the beginning of each serve, and players who serve are always at the bottom line, the position of a detected player has to be within the lower half of the court.

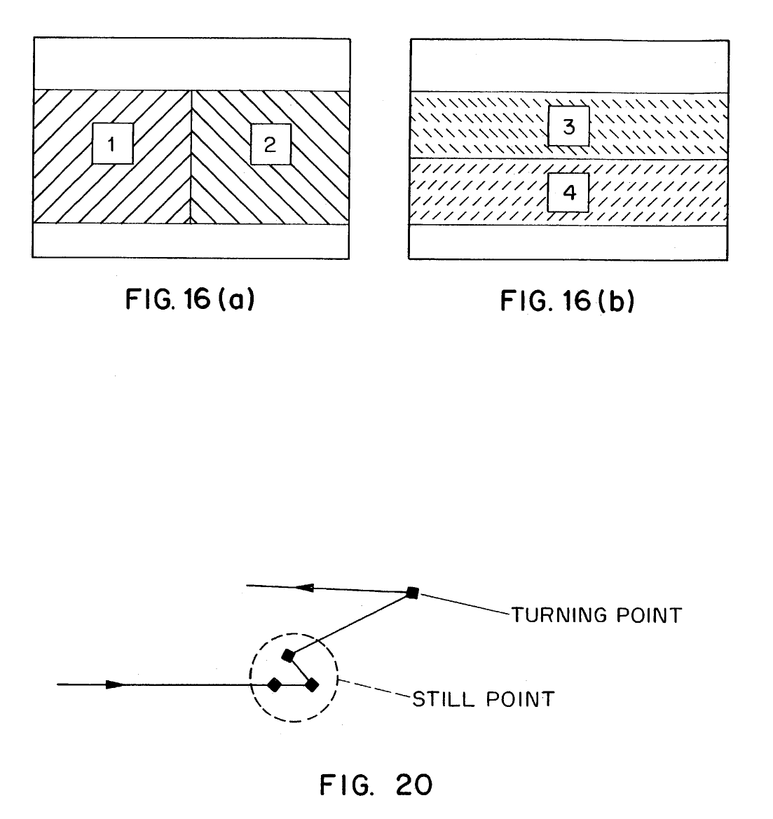

An example of edge detection using the 5×5 Sobel operator is given in FIGS. 14(a) and (b). Note that the edge detection is performed on a down-sampled (usually by 2) image and inside the detected court region. Hough transforms are conducted in four local windows to detect straight lines (FIGS. 16(a)-(b)). Referring to FIG. 16(a), windows 1 and 2 are used to detect vertical court lines, while windows 3 and 4 in FIG. 16(b) are used to detect horizontal lines. The use of local windows instead of the whole frame greatly increases the accuracy of detecting straight lines. As shown in the figure, each pair of windows roughly covers a little more than one half of a frame, and are positioned somewhat closer to the bottom border. This is based on the observation of the usual position of court lines within court views.

The verifying condition is that there are at least two vertical court lines and two horizontal court lines being detected. Note these lines have to be apart from each other, as noises and errors in edge detection and Hough transform may produce duplicated lines. This is based on the assumption that despite camera panning, there is at least one side of the court, which has two vertical lines, being captured in the video. Furthermore, camera zooming will always keep two of three horizontal lines, i.e., the bottom line, middle court line and net line, in the view.

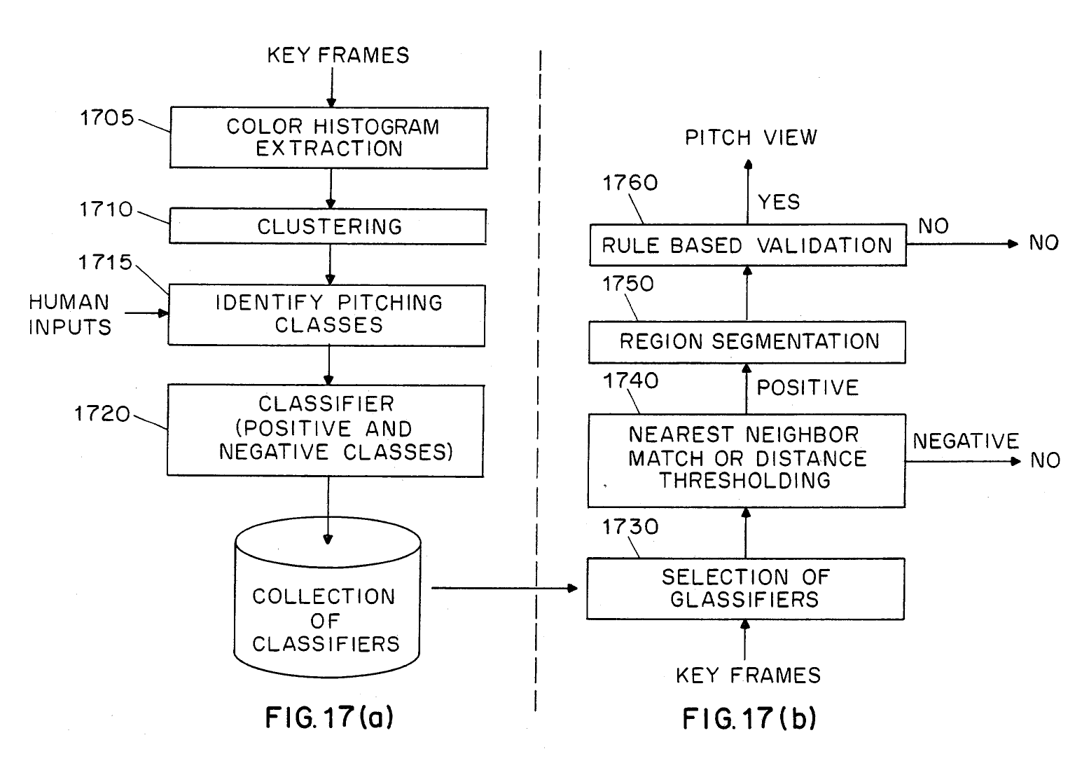

This approach also can be used for baseball video. An illustrative diagram showing the method for pitch view detection is shown in FIGS. 17(a)-(b). It contains two stages—training and detection.

In the training stage shown in FIG. 17(a), using key frames from a game segment (e.g. 20 minutes), the color histograms 1705 are first computed, and then the feature vectors are clustered 1710. As all the pitch views are visually similar and different from other views, they are usually grouped into one class (occasionally two classes). Using standard clustering techniques on the color histogram feature vectors, the pitch view class can be automatically identified 1715 with high accuracy as the class is dense and compact (i.e. has a small intra-class distance). This training process is applied to sample segments from different baseball games, and one classifier 1720 is created for each training game. This generates a collection of pitch view classifiers.

In the detection stage depicted in FIG. 17(b), visual similarity metrics are used to find similar games from the training data for key frames from digital video content. Different games may have different visual characteristics affected by the stadium, field, weather, the broadcast company, and the player's jersey. The idea is to find similar games from the training set and then apply the classifiers derived from those training games.

For finding the similar games, in other words, for selecting classifiers to be used, the visual similarity is computed between the key frames from the test data and the key frames seen in the training set. The average luminance (L) and chromiance components (U and V) of grass regions (i.e. green regions) may be used to measure the similarity between two games. This is because 1) grass regions always exist in pitch views; 2) grass colors fall into a limit range and can be easily identified; 3) this feature reflects field and lighting conditions.

Once classifiers 1730 are selected, the nearest neighbor match module 1740 is used to find the closest classes for a given key frame. If a pitch class (i.e. positive class) is returned from at least one classifier, the key frame is detected as a candidate pitch view. Note that because pitch classes have very small intra-class distances, instead of doing nearest neighbor match, in most cases we can simply use positive classes together a radius threshold to detect pitch views.

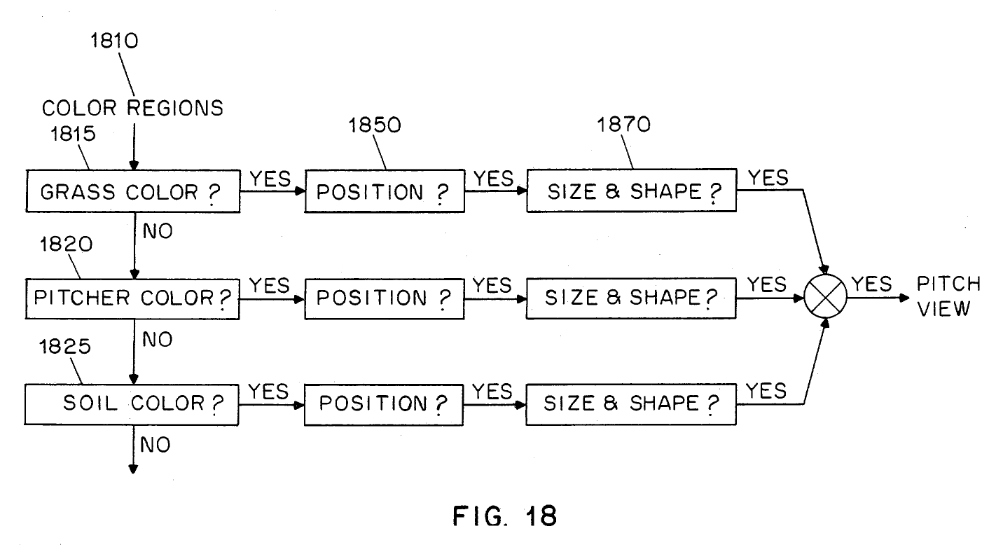

When a frame is detected as a candidate pitch view, the frame is segmented into homogenous color regions in a Region Segmentation Module 1750 for further validation. The rule-based validation process 1760 examines all regions to find the grass, soil and pitcher. These rules are based on region features, including color, shape, size and position, and are obtained through a training process. Each rule can be based on range constraints on the feature value, distance threshold to some nearest neighbors from the training class, or some probabilistic distribution models. The exemplary rule-based pitch validation process is shown in FIG. 18.

Referring to FIG. 18, for each color region 1810, its color is first used to check if it is a possible region of grass 1815, or pitcher 1820, or soil 1825. The position 1850 is then checked to see if the center of region falls into a certain area of the frame. Finally, the size and aspect ratio 1870 of the region are calculated and it is determined whether they are within a certain range. After all regions are checked, if at least one region is found for each object type (i.e., grass, pitcher, soil), the frame is finally labeled as a pitch view.

An FSU Segmentation and Indexing module 380 parses digital video content into separate FSUs using the results from different modules, such as view recognition, visual feature extraction, embedded text recognition, and matching of text from speech recognition or closed caption. The output is the marker information of the beginning and ending times of each segment and their important attributes such as the player's name, the game status, the outcome of each batter or pitch.

Using such results from low-level components and the domain knowledge, high-level content segments and events may be detected in video. For example, in baseball video, the following rules may be used to detect high-level units and events:

A new player is detected when the ball-pitch text information is reset (say to 0-0).

The last pitch of each player is detected when a pitch view is detected before a change of player.

A pitch with follow-up actions is detected when a pitch view if followed by views with camera motion, visual appearance of the field, key words from closed caption or speech recognized transcripts, or their combinations.

A scoring event is detected when the score information in the text box is detected, key words matched in the text streams (closed captions and speech transcripts), or their combinations.

Other events like home run, walk, steal, double, etc can be detected using the game state transition model. In tennis video, boundaries of important units like serve, game or set can be extracted. Events like ace, deuce, etc also can be detected.

With these high-level events and units detected, users may access the video in a very efficient way (e.g., browse pitch by pitch or player by player). As a result, important segments of the video can be further streamed with higher quality to the user

An Event Detection module 385 detects important events in specific domains by integrating constituent features from different modalities. For example, a hit-and-score event in baseball may consist of a pitch view, followed by a tracking view, a base running view, and the update of the embedded score text. Start of a new batter may be indicated by the appearance of player introduction text on the screen or the reset of ball count information contained in the embedded text. Furthermore, a moving object detection may also be used to determine special events. For example, in tennis, a tennis player can be tracked and his/her trajectory analyzed to obtain interesting events.

An automatic moving object detection method may contain two stages: an iterative motion layer detection step being performed at individual frames; and a temporal detection process combining multiple local results within an entire shot. This approach may be adapted to track tennis players within court view in real time. The focus may be on the player who is close to the camera. The player at the opposite side is smaller and not always in the view. It is harder to track small regions in real time because of down-sampling to reduce computation complexity.

Down-sampled I- and P-frames are segmented and compared to extract motion layers. B-frames are skipped because bi-direction predicted frames require more computation to decode. To ensure real-time performance, only one pair of anchor frames is processed every half second. For a MPEG stream with a GOP size of 15 frames, the I-frame and its immediate following P-frame are used. Motion layer detection is not performed in later P frames in the GOP. This change requires a different temporal detection process to detection moving objects. The process is described as follows.

As a one half-second is a rather large gap for the estimation of motion fields, motion-based region projection and tracking from 1 frame to another I frame are not reliable, especially when the scene contains fast motion. Thus, a different process is required to match moving layers detected at individual I-frames. A temporal filtering process may be used to select and match objects that are detected at I frames.

Assume that Oᵢ^{k} is the k-th object (k=1, . . . , K) at the i-th I-frame in a video shot, [symbol] , \overline{c}ᵢ^{k} and sᵢ^{k} are the center position, mean color and size of the object respectively. The distance between Oᵢ^{k} and another object at j-th I-frame, Oⱼ^{l}, is defined as weighted sum of spatial, color and size differences.

$$D ( {O}_{i}^{k} , {O}_{j}^{l} ) = {w}_{p} ‖ {\vec{p}}_{i}^{k} - {\vec{p}}_{j}^{l} ‖ + {w}_{c} ‖ {\vec{c}}_{i}^{k} - {\vec{c}}_{j}^{l} ‖ + {w}_{s} \vert {s}_{i}^{k} - {s}_{j}^{l} \vert \qquad ( 7 )$$

where wₚ, w_{c} and wₛ are weights on spatial, color and size differences respectively. If D(Oᵢ^{k},Oⱼ^{l}) is smaller than a given threshold, O_TH, objects oᵢ^{k} and Oⱼ^{l} match with each other. We then define the match between an object with its neighboring I-frame i+δ as follows,

$$F ( {O}_{i}^{k} , i + δ ) = \{ \begin{matrix}1 & ∃ {O}_{i + δ}^{l} , D ( {O}_{i}^{k} , {O}_{i + δ}^{l} ) < O\_TH \\ 0 & otherwise\end{matrix} , \qquad ( 8 )$$

where

$$δ = \pm 1 , … , n . Let {M}_{i}^{k} = {\sum }_{δ = \pm 1 , … , n} F ( {O}_{i}^{k} , i + δ )$$

be the total number of frames that have matches of object Oᵢ^{k}(k=1, . . . , K) within the period i−δ to i+δ, we select the object with maximum Mᵢ^{k}. This means that if

$${M}_{i}^{r} = {max}_{k = 1 , … , K} ( {M}_{i}^{k} ) ,$$

the r-th object is kept at the i-th I-frame. The other objects are dropped. The above process can be considered as a general temporal median filtering operation.

After the above selection, the trajectory of the lower player is obtained by sequentially taking the center coordinates of the selected moving objects at all I-frames. There are several issues associated with this process. First, if no object is found in the frame, linear interpolation is used to fill the missing point. When there are more than one objects being selected in the frame (in the situation when more than one objects have the same maximum number), the one that is spatially close to its precedent is used. In addition, for speed reason, instead of using affine model to compensate camera motion, the detected net lines may be used to roughly align different instances.

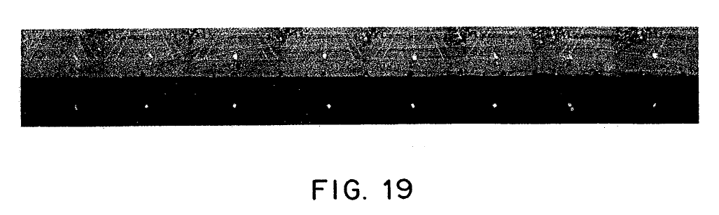

Referring to FIG. 19, a tracking of moving objects is illustrated. The first row shows the down-sampled frames. The second row contains final player tracking results. The body of the player is tracked and detected. Successful tracking of tennis players provides a foundation for high-level semantic analysis.

The extracted trajectory is then analyzed to obtain play information. The first aspect on which the tracking may be focused is the position of a player. As players usually play at serve lines, it may be of interest to find cases when players moves to the net zone. The second aspect is to estimate the number of strikes the player had in a serve. Users who want to learn strike skills or play strategies may be interested in serves with more strikes.

Given a trajectory containing K coordinates, \overline{p}ₖ(k=1, . . . , K), at K successive I-frames, “still points” and “turning points” may be detected first. \overline{p}ₖ is a still point if,

min(∥\overline{p}ₖ−\overline{p}ₖ₋₁∥,∥\overline{p}ₖ−\overline{p}ₖ₊₁∥)<TH, (9)

where TH is a pre-defined threshold. Furthermore, two consecutive still points are merged into one. If point \overline{p}ₖ is not a still point, the angle at the point is examined. \overline{p}ₖ is a turning point if

∠(pₖpₖ₋₁,PₖPₖ₊₁)<90° (10).

An example of object trajectory is shown in FIG. 20. After detecting still and turning points, such points may be used to determine the player's positions. If there is a position close to the net line (vertically), the serve is classified as a net-zone play. The estimated number of strokes is the sum of the numbers of turning and still points.

Experimental results of a one-hour video described above are given in Table 2.

TABLE 1
Trajectory analysis results for
one hour tennis video

| | # of Net Plays | # of Strokes |
|---|---|---|
| Ground Truth | 12 | 221 |
| Correct Detection | 11 | 216 |
| False Detection | 7 | 81 |

In the video, the ground truth includes 12 serves with net play within about 90 serve scenes (see Table 1), and totally 221 strokes in all serves. Most net plays are correctly detected. False detection of net plays is mainly caused by incorrect extraction of player trajectories or court lines. Stroke detection has a precision rate about 72%. Beside the reason of incorrect player tracking, some errors may occur. First, at the end of a serve, a player may or may not strike the ball in his or her last movement. Many serve scenes also show players walking in the field after the play. In addition, a serve scenes sometimes contain two serves if the first serve failed. These may cause problems since currently we detect strokes based on the movement information of the player. To solve these issues, more detailed analysis of motion such as speed, direction, repeating patterns in combination with audio analysis (e.g., hitting sound) may be needed.

The extracted and recognized information obtained by the above system can be used in database application such as high-level browsing and summarization, or streaming applications such as the adaptive streaming. Note that users may also play an active role in correcting errors or making changes to these automatically obtained results. Such user interaction can be done in real-time or off-line.

The video programs may be analyzed and important outputs may be provided as index information of the video at multiple levels. Such information may include the beginning and ending of FSUs, the occurrence of important events (e.g., hit, run, score), links to video segments of specific players or events. These core technologies may be used in video browsing, summarization, and streaming.

Using the results from these parsing and indexing methods, a system for video browsing and summarization may be created. Various user interfaces may be used to provide access to digital video content that is parsed into fundamental semantic units and indexed.

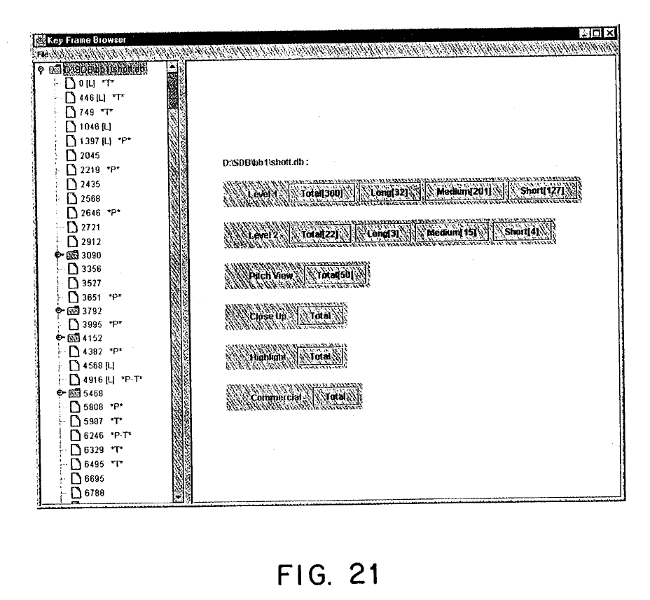

Referring to FIG. 21, a summarization interface which shows the statistics of video shots and views is illustrated. For example, such interface may provide the statistics of relating to the number of long, medium, and short shots, number of types of views, and variations of these numbers when changing the parsing parameters. These statistics provide an efficient summary for the overall structure of the video program. After seeing these summaries, users may follow up with more specific fundamental semantic unit requirements. For example, the user may request to see a view each of the long shots or the pitch views in details. Users can also use such tools in verifying and correcting errors in the results of automatic algorithms for video segmentation, view recognition, and event detection.

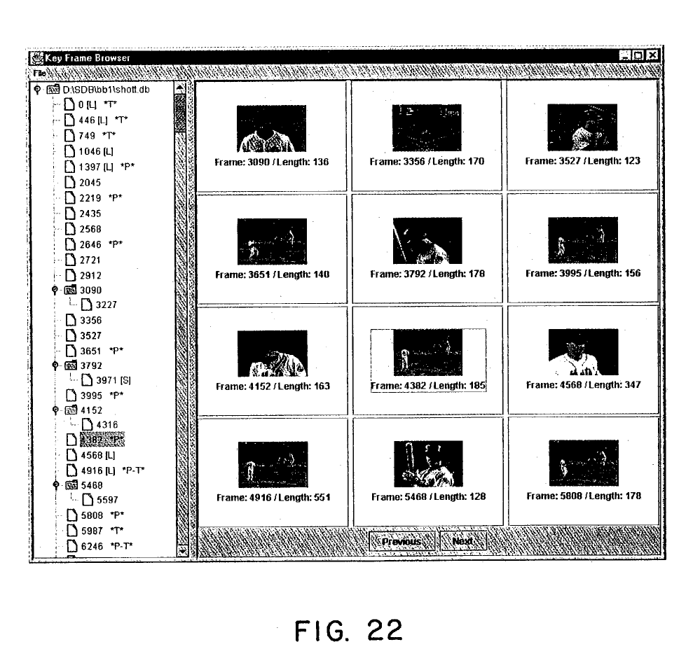

Referring to FIG. 22, a browsing interface that combines the sequential temporal order and the hierarchical structure between all video shots is illustrated. Consecutive shots sharing some common theme can be grouped together to form a node (similar to the “folder” concept on Windows). For example, all of the shots belonging to the same pitch can be grouped to a “pitch” folder; all of the pitch nodes belonging to the same batter can be grouped to a “batter” node. When any node is opened, the key frame and associated index information (e.g., extracted text, closed caption, assigned labels) are displayed. Users may search over the associate information of each node to find specific shots, views, or FSUs. For example, users may issue a query using keywords “score” to find FSUs that include score events.

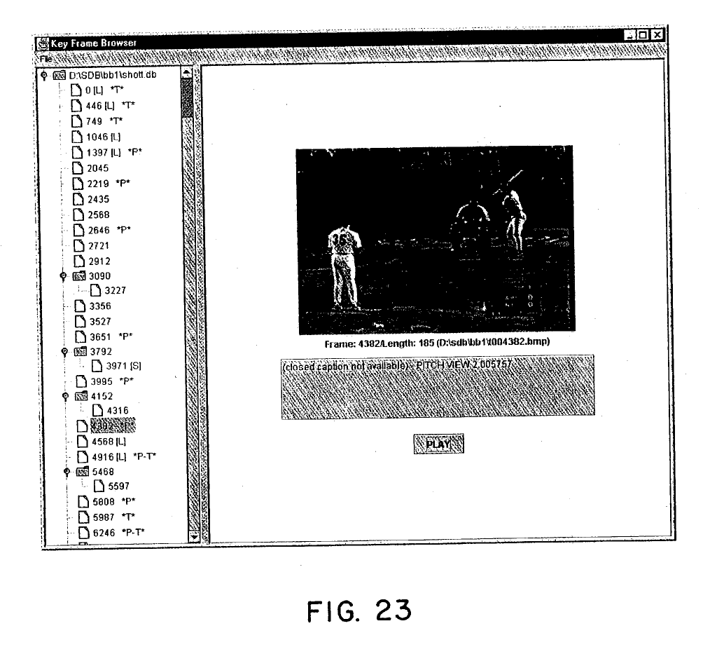

Referring to FIG. 23, a browsing interface with random access is illustrated. Users can randomly access any node in the browsing interface and request to playback the video content corresponding to that node.

The browsing system can be used in professional or consumer circles for various types of videos (such as sports, home shopping, news etc). In baseball video, users may browse the video shot by shot, pitch by pitch, player by player, score by score, or inning by inning. In other words, users will be able to randomly position the video to the point when significant events occur (new shot, pitch, player, score, or inning).

Such systems also can be integrated in the so called Personal Digital Recorders (PDR), which can instantly store live video at the personal digital device and support replay, summarization, and filtering functions of the live or stored video. For example, using the PDR, users may request to skip non-important segments (like non-action views in baseball games) and view other segments only.

The results from the video parsing and indexing system can be used to enhance the video streaming quality by using a method for Content-Based Adaptive Streaming described below. This method is particularly useful for achieving high-quality video over bandwidth-limited delivery channels (such as Internet, wireless, and mobile networks). The basic concept is to allocate high bit rate to important segments of video and minimal bit rate for unimportant segments. Consequently, the video can be streamed at a much lower average rate over wireless or Internet delivery channels. The methods used in realizing such content-based adaptive streaming include the parsing/indexing which was previously described, semantic adaptation (selecting important segments for high-quality transmission), adaptive encoding, streaming scheduling, and memory management and decoding on the client side, as depicted in FIG. 6.

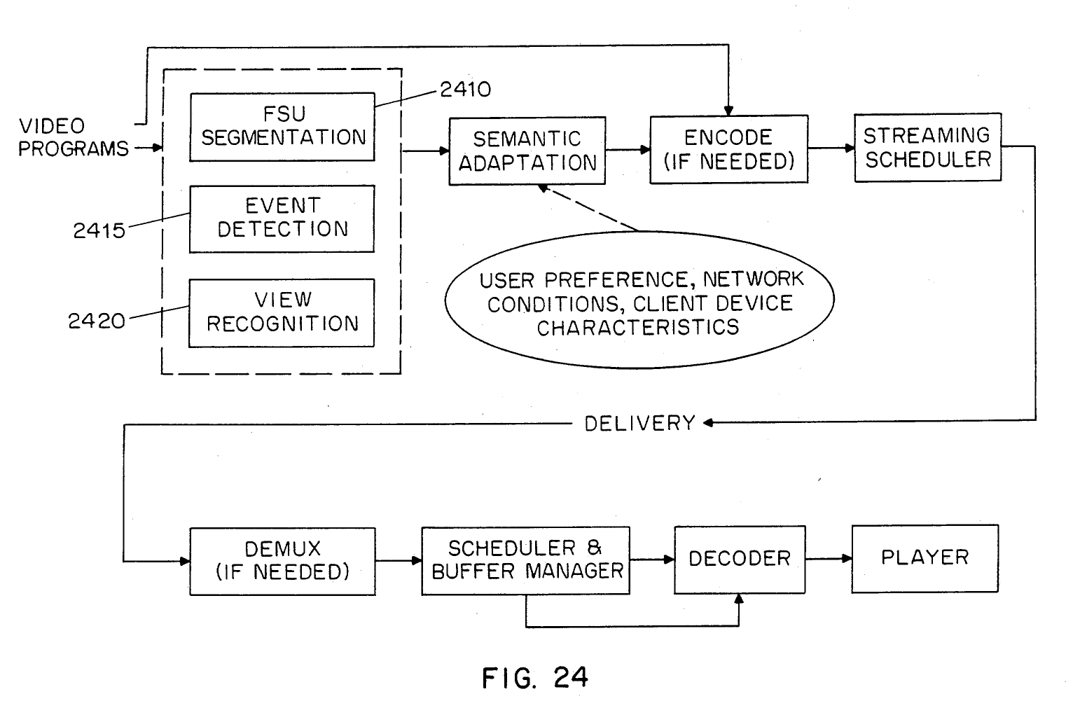

Referring to FIG. 24, an illustrative diagram of content-based adaptive streaming is shown. Digital video content is parsed and analyzed for video segmentation 2410, event detection 2415, and view recognition 2420. Depending on the application requirements, user preferences, network conditions, and user device capability, selected segments can be represented with different quality levels in terms of bit rate, frame rate, or resolution.

User preferences may play an important role in determining the criteria for selecting important segments of the video. Users may indicate that they want to see all hitting events, all pitching views, or just the scoring events. The amount of the selected important segments may depend on the current network conditions (i.e., reception quality, congestion status) and the user device capabilities (e.g., display characteristics, processing power, power constraints etc.)

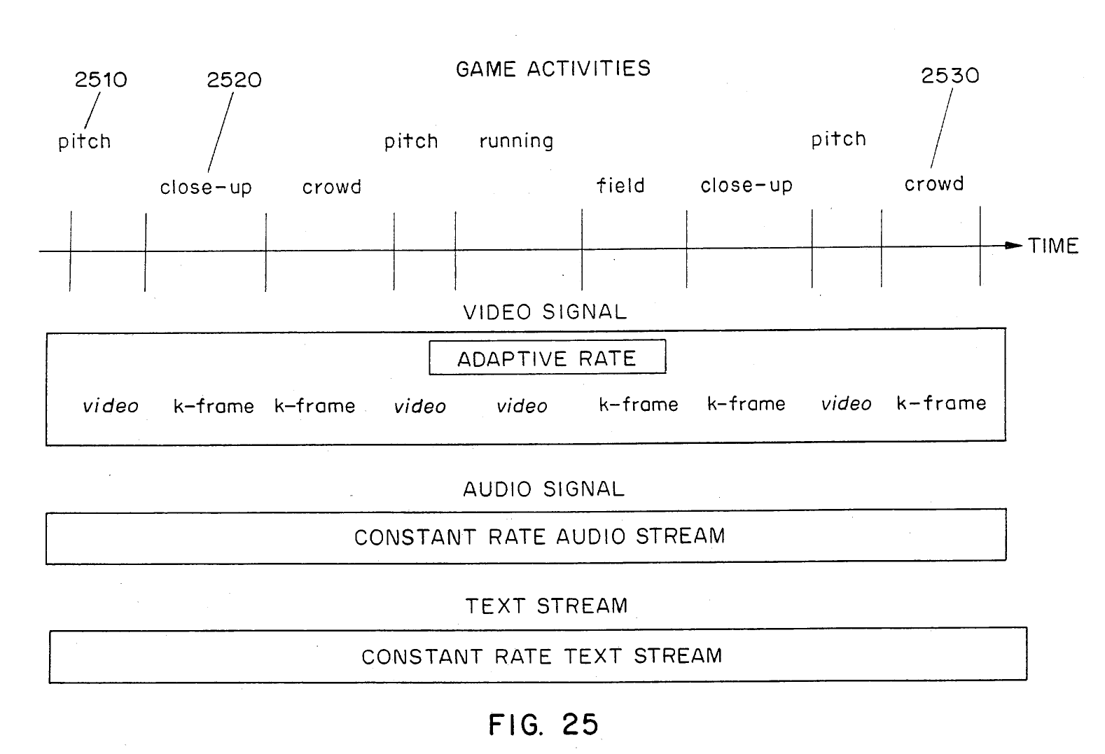

Referring to FIG. 25, an exemplary content-specific adaptive streaming of baseball video is illustrated. Only the video segments corresponding to the pitch views and “actions” after the pitch views 2510 are transmitted with full-motion quality. For other views, such as close-up views 2520 or crowd views 2530, only the still key frames are transmitted. The action views may include views during which important actions occur after pitching (such as player running, camera tracking flying ball, etc.). Camera motions, other visual features of the view, and speech from the commentators can be used to determine whether a view should be classified as an action view. Domain specific heuristics and machine learning tools can be used to improve such decision-making process. The following include some exemplary decision rules:

For example, every view after the pitch view may be transmitted with high quality. This provides smooth transition between consecutive segments. Usually, the view after the pitch view provides interesting information about the player reaction too. Conversely, certain criteria can be used to detect action views after the pitch views. Such criteria may include appearance of the motion in the field, camera motions (e.g., zooming, panning, or both), or combination of both. Usually, if there is “action” following the pitch, the camera covers the field with some motions.

As shown in FIG. 25, transmission of video may be adaptive, taking into account the importance of each segment. Hence, some segments will be transmitted to the users with high quality levels, whereas other segments may be transmitted as still key frames. Therefore, the resulting bit rate of the video may be variable. Note that the rate for the audio and text streams remains the same (fixed). In other words, users will receive the regular audio and text streams while the video stream alternates between low rate (key frames) and high rate (full-motion video). In FIG. 25, only the pitch view and important action views after each pitch view are transmitted with high-rate video.

The following example illustrates the realization of high-quality video streaming over a low-bandwidth transmission channels. Assuming that the available channel bandwidth is 14.4 Kbps, out of which 4.8 Kbps is allocated to audio and text, only 9.6 Kbps remains available for video. Using the content-based adaptive streaming technology, and assuming that 25% of the video content is transmitted with full-motion quality while the rest is transmitted with key frames only, a four-fold bandwidth increase may be achieved during the important video segments at the 38.4 Kbps. For less important segments, full-rate audio and text streams are still available and the user can still follow the content even without seeing the full-motion video stream.

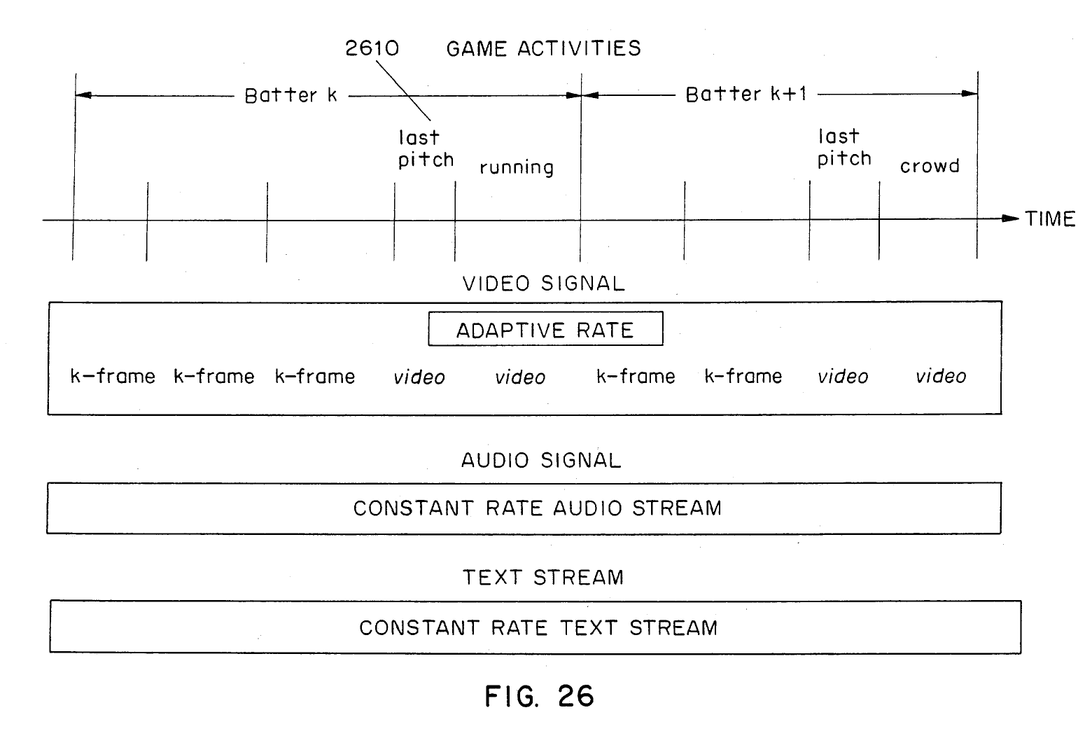

Note that the input video for analysis may be in different formats from the format that is used for streaming. For example, some may include analysis tools in the MPEG-1 compressed domain while the final streaming format may be Microsoft Media or Real Media. The frame rate, spatial resolution, and bit-rate also may be different. FIG. 24 shows the case in which the adaptation is done within each pitch interval. The adaptation may also be done at higher levels, as in FIG. 26.

Referring to FIG. 26, the exemplary adaptation is done at a higher level (FSU=batter). For example, only the last pitch 2610 of each batter is transmitted with the full-motion quality. The rest of the video is transmitted with key frames only. Assuming that the batter receives 5 pitches on the average, a twenty-fold bandwidth increase may be achieved during the important segments of the video. The equivalent bit rate for the important segments is 192 Kbps in this case.

Content-based adaptive streaming technique also can be applied to other types of video. For example, typical presentation videos may include views of the speaker, the screen, Q and A sessions, and various types of lecture materials. Important segments in such domains may include the views of slide introduction, new lecture note description, or Q and A sessions. Similarly, audio and text may be transmitted at the regular rate while video is transmitted with an adaptive rate based on the content importance.

Since different video segments may have different quality levels, they may have variable bit rates. Thus, a method for scheduling streaming of the video data over bandwidth-limited links may be used to enable adaptive streaming of digital video content to users.

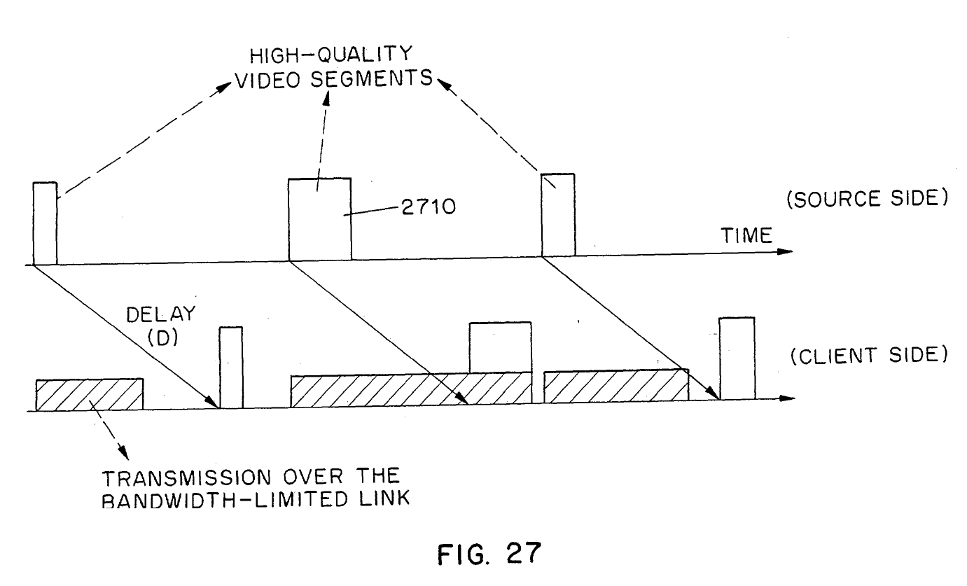

As shown in FIG. 27, the available link bandwidth (over wireless or Internet) may be Lbps, the video rate during the high-quality segments Hbps, and the startup delay for playing the video at the client side may be D sec. Furthermore, the maximum duration of high quality video transmission may be T max seconds. The following relationship holds:

(D+T_max)×L=T_max×H, (11)

where the left side of the above equation represents the total amount of data transmitted when the high-quality segment reaches the maximal duration (e.g., the segment 2710 shown in the middle of FIG. 27). This amount should be equal the total amount of data consumed during playback (the right side of the equation).

The above equation can also be used to determine the startup delay, the minimal buffer requirement at the client side, and the maximal duration of high-quality video transmission. For example, if T_max, H, and L are given, D is lower bounded as follows:

D>=T_max×(H/L−1) (12).

If T_max is 10 seconds and HAL is 4 (like the example mentioned earlier, H=38.4 Kbps, L=9.6 Kbps), then the startup delay is 30 seconds.

If L and D are given, then the client buffer size (B) is lower bounded as follows:

B>=D×L. (13)

Using the same example (D=30 sec, L=9.6 Kbps), the required client buffer size is 288K bits (36 K bytes).

The foregoing merely illustrates the principles of the invention. Various modifications and alterations to the described embodiments will be apparent to those skilled in the art in view of the teachings herein. For example, the above content-based adaptive video streaming method can be applied in any domain in which important segments can be defined. In baseball, such important segments may include every pitch, last pitch of each player, or every scoring. In newscasting, story shots may be the important segments; in home shopping—product introduction; in tennis—hitting and ball tracking views etc.

It will thus be appreciated that those skilled in the art will be able to devise numerous techniques which, although not explicitly shown or described herein, embody the principles of the invention and are thus within the spirit and scope of the invention.

1. A method for indexing and summarizing digital video content, comprising the steps of:
a) receiving digital video content;
b) automatically parsing digital video content into one or more fundamental semantic units based on a set of predetermined domain-specific cues;
c) determining corresponding attributes for each of said fundamental semantic units to provide indexing information for said fundamental semantic units; and
d) arranging one or more of said fundamental semantic units with one or more of said corresponding attributes for display and browsing.

2. The method of claim 1, wherein said step of automatically parsing digital video content further comprises the steps of:
a) automatically extracting a set of features from digital video content based on said predetermined set of domain-specific cues;
b) recognizing one or more domain-specific segments based on said set of features for parsing digital video content; and
c) parsing digital video content into one or more fundamental semantic units corresponding to said one or more domain-specific segments.

3. The method of claim 2, wherein said one or more domain-specific segments are views.

4. The method of claim 2, wherein said one or more domain-specific segments are events.

5. The method of claim 2, wherein said set of features from digital video content includes a set of visual features.

6. The method of claim 2, wherein said set of features from digital video content includes a set of audio features.

7. The method of claim 2, wherein said step of automatically extracting a set of features from digital video content further comprises a step of recognizing speech signals.

8. The method of claim 7, wherein said step of recognizing speech signals further comprises a step of converting said speech signals to recognized text data.

9. The method of claim 2, wherein said step of automatically extracting a set of features from digital video content further comprises a step of decoding closed caption information from digital video content.

10. The method of claim 2, wherein said step of automatically extracting a set of features from digital video content further comprises the steps of:
a) detecting text images in said digital video content; and
b) converting said text images into text information.

11. The method of claim 10, wherein said step of detecting text images further comprises the steps of:
a) computing a set of frame-to-frame motion measures;
b) comparing said set of frame-to-frame motion measures with a set of predetermined threshold values; and
c) determining one or more candidate text areas based on said comparing.

12. The method of claim 11, further comprising the step of removing noise from said one or more candidate text areas.

13. The method of claim 12, further comprising the step of applying domain-specific spatio-temporal constraints to remove detection errors from said one or more candidate text areas.

14. The method of claim 12, further comprising the step of color-histogram filtering said one or more candidate text areas to remove detection errors.

15. The method of claim 10, wherein said step of converting said text images into text information further comprises the steps of:
a) computing a set of temporal features for frame-to-frame differences of said one or more candidate text areas;
b) computing a set of spatial features of an intensity projection histogram for said one or more candidate text areas containing peaks or valleys;
c) determining a set of text character sizes and spatial locations of one or more characters located within said one or more candidate text areas based on said set of temporal features and said said of spatial features; and
d) comparing said one or more characters to a set of pre-determined template characters to convert text images into text information.

16. The method of claim 2, wherein said step of automatically extracting a set of features from digital video content further comprises a step of synchronizing a timing information between said set of features.

17. The method of claim 2, wherein said step of automatically extracting a set of features from digital video content further comprises a step of detecting scene changes.

18. The method of claim 17, wherein said step of detecting scene changes comprises a step of automatically detecting flashlights.

19. The method of claim 18, wherein said step of detecting flashlights further comprises the steps of:
a) calculating a frame-to-frame color difference of each frame;
b) calculating a corresponding long-term color difference;
c) computing a ratio of said frame-to-frame color difference to said long term color difference; and
d) comparing said ratio with a pre-determined threshold value to detect flashlights.

20. The method of claim 17, wherein said step of detecting scene changes further comprises a step of automatically detecting direct scene changes.

21. The method of claim 20, wherein said step of detecting direct scene changes further comprises the step of computing a frame-to-frame color difference for each frame.

22. The method of claim 17, wherein said step of detecting scene changes further comprises the steps of:
a) determining one or more intra-block motion vectors from digital video content;
b) determining a set of corresponding forward-motion vectors for each of said intra-block motion vectors;
c) determining a set of corresponding backward-motion vectors for each of said intra-block motion vectors; and
d) computing a ratio of said one or more intra-block motion vectors and said corresponding forward-motion vectors and backward motion vectors to detect scene changes.

23. The method of claim 17, wherein said step of detecting scene changes further comprises the step of computing a set of color differences from a local window of each digital video frame to detect gradual scene changes

24. The method of claim 17, wherein said step of detecting scene changes further comprises a step of detecting camera aperture changes.

25. The method of claim 24, wherein said step of detecting camera aperture changes further comprises the steps of:
a) computing color differences between adjacent detected scene changes; and
b) comparing said color differences with a pre-determined threshold value to detect camera aperture changes.

26. The method of claim 17, wherein said step of detecting scene changes further comprises the steps of:
a) determining a set of threshold levels using a decision tree based on a set of predetermined parameters; and
b) automatically detecting corresposnding multi-level scene changes for said set of threshold levels.

27. The method of claim 2, further comprising the step of integrating one or more of said domain-specific segments to form a domain-specific event for display.

28. The method of claim 2, wherein said set of predetermined domain-specific cues is determined based on user preferences.

29. The method of claim 2, wherein said predetermined domain-specific cues are either one of color, motion or object layout.

30. The method of claim 2, wherein said step of recognizing one or more domain-specific segments further comprises a fast adaptive color filtering of digital video content to select possible domain-specific segments.

31. The method of claim 30, wherein said fast adaptive color filtering is based on one or more pre-trained filtering models.

32. The method of claim 31, wherein such filtering models are built through a clustering-based training process.

33. The method of claim 30, wherein said step of recognizing one or more domain-specific segments further comprises a segmentation-based verification for verifying domain-specific segments based on a set of pre-determined domain-specific parameters.

35. The method of claim 33, wherein said segmentation-based verification comprises a salient feature region extraction.

36. The method of claim 33, wherein said segmentation-based verification comprises a moving object detection.

37. The method of claim 33, wherein said segmentation-based verification comprises a similarity matching scheme of visual and structure features.

38. The method of claim 30, wherein said step of recognizing one or more domain-specific segments further comprises an edge-based verification for verifying domain-specific segments based on a set of pre-determined domain-specific parameters.

39. A method for content-based adaptive streaming of digital video content, comprising the steps of:
a) receiving digital video content;
b) automatically parsing said digital video content into one or more video segments based on a set of predetermined domain-specific cues for adaptive streaming;
c) assigning corresponding video quality levels to said video segments based on a set of predetermined domain-specific requirements;
d) scheduling said video segments for adaptive streaming to one or more users based on corresponding video quality levels; and
e) adaptively streaming said video segments with corresponding video quality levels to users for display and browsing.

40. The method of claim 39, wherein said step of automatically parsing said digital video content further includes the steps of:
a) automatically extracting a set of features from said digital video content based on said predetermined set of domain-specific cues;
b) recognizing one or more domain-specific segments based on said set of features for parsing said digital video content; and
c) parsing said digital video content into one or more fundamental semantic units corresponding to said domain-specific segments.

41. The method of claim 40, wherein said one or more domain-specific segments are views.

42. The method of claim 40, wherein said one or more domain-specific segments are events.

43. The method of claim 40, wherein said set of features from said digital video content includes a set of visual features.

44. The method of claim 40, wherein said set of features from said digital video content includes a set of audio features.

45. The method of claim 40, wherein said step of automatically extracting a set of features from said digital video content further comprises a step of recognizing speech signals.

46. The method of claim 45, wherein said step of recognizing speech signals further comprises a step of converting said speech signals to recognized text data.

47. The method of claim 40, wherein said step of automatically extracting a set of features from digital video content further comprises a step of decoding closed caption information from said digital video content.

48. The method of claim 40, wherein said step of automatically extracting a set of features from said digital video content further comprises the steps of:
a) detecting text images in said digital video content; and
b) converting said text images into text information.

49. The method of claim 48, wherein said step of detecting text images further comprises the steps of:
a) computing a set of frame-to-frame motion measures;
b) comparing said set of frame-to-frame motion measures with a set of predetermined threshold values; and
c) determining one or more candidate text areas based on said comparing.

50. The method of claim 49, further comprising the step of removing noise from said one or more candidate text areas.

51. The method of claim 50, further comprising the step of applying domain-specific spatio-temporal constraints to remove detection errors from said one or more candidate text areas.

52. The method of claim 50, further comprising the step of color-histogram filtering said one or more candidate text areas to remove detection errors.

53. The method of claim 48, wherein said step of converting said text images into text information further comprises the steps of:
a) computing a set of temporal features for frame-to-frame differences of said one or more candidate text areas;
b) computing a set of spatial features of an intensity projection histogram for said one or more candidate text areas containing peaks or valleys;
c) determining a set of text character sizes and spatial locations of one or more characters located within said one or more candidate text areas based on said set of temporal features and said said of spatial features; and
d) comparing said one or more characters to a set of pre-determined template characters to convert text images into text information.

54. The method of claim 40, wherein said step of automatically extracting a set of features from digital video content further comprises a step of synchronizing timing information between said set of features.

55. The method of claim 40, wherein said step of automatically extracting a set of features from digital video content further comprises a step of detecting scene changes.

56. The method of claim 55, wherein said step of detecting scene changes comprises a step of automatically detecting flashlights.

57. The method of claim 56, wherein said step of detecting flashlights further comprises the steps of:
a) calculating a frame-to-frame color difference of each frame;
b) calculating a corresponding long-term color difference;
c) computing a ratio of said frame-to-frame color difference to said long term color difference; and
d) comparing said ratio with a pre-determined threshold value to detect flashlights.

58. The method of claim 55, wherein said step of detecting scene changes further comprises a step of automatically detecting direct scene changes.

59. The method of claim 58, wherein said step of detecting direct scene changes further comprises the step of computing a frame-to-frame color difference for each frame.

60. The method of claim 55, wherein said step of detecting scene changes further comprises the steps of:
a) determining one or more intra-block motion vectors from digital video content;
b) determining a set of corresponding forward-motion vectors for each of said intra-block motion vectors;
c) determining a set of corresponding backward-motion vectors for each of said intra-block motion vectors; and
d) computing a ratio of said one or more intra-block motion vectors and said corresponding forward-motion vectors and backward motion vectors to detect scene changes.

61. The method of claim 55, wherein said step of detecting scene changes further comprises the step of computing a set of color differences from a local window of each digital video frame to detect gradual scene changes

62. The method of claim 55, wherein said step of detecting scene changes further comprises a step of detecting camera aperture changes.

63. The method of claim 62, wherein said step of detecting camera aperture changes further comprises the steps of:
a) computing color differences between adjacent detected scene changes; and
b) comparing said color differences with a predetermined threshold value to detect camera aperture changes.

64. The method of claim 55, wherein said step of detecting scene changes further comprises the steps of:
a) determining a set of threshold levels using a decision tree based on a predetermined set of parameters; and
b) automatically detecting corresponding multi-level scene changes for said set of threshold levels.

65. The method of claim 40, further comprising the step of integrating one or more of domain-specific segments to form a domain-specific event for display.

66. The method of claim 40, wherein said set of predetermined domain-specific cues is determined based on user preferences.

67. The method of claim 40, wherein said predetermined domain-specific cues are either one of color, motion or object layout.

68. The method of claim 40, wherein said step of recognizing one or more domain-specific segments further comprises a fast adaptive color filtering of digital video content to select possible domain-specific segments.

69. The method of claim 68, wherein said fast adaptive color filtering is based on one or more filtering models.

70. The method of claim 69, wherein said filtering models are built through a clustering-based training process.

71. The method of claim 68, wherein said step of recognizing one or more domain-specific segments further comprises a segmentation-based verification for verifying domain-specific segments based on a set of pre-determined domain-specific parameters.

72. The method of claim 71, wherein said segmentation-based verification comprises a salient feature region extraction.

73. The method of claim 71, wherein said segmentation-based verification comprises a moving object detection.

74. The method of claim 71, wherein said segmentation-based verification comprises a similarity matching scheme of visual and structure features.

75. The method of claim 71, wherein said step of recognizing one or more domain-specific segments further comprises an edge-based verification for verifying domain-specific segments based on a set of pre-determined domain-specific parameters.

78. A system for indexing digital video content, comprising:
a means for receiving digital video content;
a means, coupled to said receiving means, for automatically parsing digital video content into one or more fundamental semantic units based on a set of predetermined domain-specific cues;
a means, coupled to said parsing means, for determining corresponding attributes for each of said fundamental semantic units; and
a means, coupled to said parsing means and said determining means, for arranging one or more of said fundamental semantic units with one or more of said corresponding attributes for browsing.

79. The system of claim 78, wherein said means for automatically parsing digital video content further comprises:
a) a means, coupled to said receiving means, for automatically extracting a set of features from digital video content based on said predetermined set of domain-specific cues;
b) a means, coupled to said extracting means, for recognizing one or more domain-specific segments based on said set of features for parsing digital video content;
c) a means, coupled to said recognizing means, for parsing digital video content into one or more fundamental semantic units corresponding to said one or more domain-specific segments.

80. The system of claim 79, wherein said one or more domain-specific segments are views.

81. The system of claim 79, wherein said one or more domain-specific segments are events.

82. The system of claim 79, wherein said set of features from said digital video content includes a set of visual features.

83. The system of claim 79, wherein said set of features from said digital video content includes a set of audio features.

84. The system of claim 79, wherein said extracting means further comprises a means for recognizing speech signals.

85. The system of claim 84, wherein said means for recognizing speech signals converts said speech signals into recognized text data.

86. The system of claim 79, wherein said extracting means comprises a means for decoding closed caption information from said digital video content.

87. The system of claim 79, wherein said extracting means detects text images in said digital video content and converts said text images into text information.

88. The system of claim 87, wherein said extracting means computes a set of frame-to-frame motion measures, compares said set of frame-to-frame motion measures with a set of predetermined threshold values to determine one or more candidate text areas.

89. The system of claim 88, wherein said extracting means further removes noise from said one or more candidate text areas.

90. The system of claim 89, wherein said extracting means further applies domain-specific spatio-temporal constraints to remove detection errors from said one or more candidate areas.

91. The system of claim 90, wherein said extracting means further applies color-histogram filtering on said one or more candidate text areas to remove detection errors.

92. The system of claim 79, wherein said extracting means synchronizes a timing information between said set of features.

92. The system of claim 79, wherein said extracting means comprises a detector of scene changes.

93. The system of claim 92, wherein said detector of scene changes comprises an automatic flashlight detector.

94. The system of claim 93, wherein said automatic flashlight detector comprises a comparator for comparing a ratio of a frame-to-frame color difference for each frame to a corresponding long-term color difference to detect flashlights.

95. The system of claim 92, wherein said detector of scene changes comprises an automatic detector of direct scene changes.

96. The system of claim 92, wherein said detector of scene changes comprises an automatic detector of gradual scene changes.

97. The system of claim 92, wherein said detector of scene changes comprises a detector of camera aperture changes.

98. The system of claim 79, wherein said set of pre-determined domain-specific cues is determined based on user preferences.

99. The system of claim 79, wherein said set of pre-determined domain-specific cues is either of color, motion and object layout.

100. The system of claim 79, wherein said means for recognizing one or more domain-specific segments comprises a fast adaptive color filter for selecting possible domain-specific segments.

101. The system of claim 100, wherein said adaptive color filter uses one or more pre-trained filtering models built through a clustering-based training.

102. The system of claim 101, wherein said means for recognizing one or more domain-specific segments comprises a segmentation-based verification module for verifying domain-specific segments based on a set of pre-determined domain-specific parameters.

103. The system of claim 102, wherein said segmentation-based verification module comprises a salient-feature region extraction module.

104. The system of claim 103, wherein said segmentation-based verification module further comprises a moving object detection module.

105. The system of claim 104, wherein said segmentation-based verification module further comprises a similarity matching of visual and structure features module.

106. The system of claim 105, wherein said means for recognizing one or more domain-specific segments comprises an edge-based verification module for verifying domain-specific segments based on a set of pre-determined domain-specific parameters.

107. A system for content-based adaptive streaming of digital video content, comprising:
a means for receiving digital video content;
a means, coupled to said receiving means, for automatically parsing digital video content into one or more fundamental semantic units based on a set of predetermined domain-specific cues;
a means, coupled to said parsing means, for assigning corresponding video-quality levels to said video segments based on a set of predetermined content-specific requirements;
a means, coupled to said assigning means and said parsing means, for scheduling said video segments for adaptive streaming to one or more users based on corresponding video quality levels; and
a means, coupled to said scheduling means, for adaptively streaming said video segments with corresponding video quality levels to users for display.

108. The system of claim 107, wherein said means for automatically parsing digital video content further comprises:
a) a means, coupled to said receiving means, for automatically extracting a set of features from digital video content based on said predetermined set of domain-specific cues;
b) a means, coupled to said extracting means, for recognizing one or more domain-specific segments based on said set of features for parsing digital video content;
c) a means, coupled to said recognizing means, for parsing digital video content into one or more fundamental semantic units corresponding to said one or more domain-specific segments.

109. The system of claim 108, wherein said one or more domain-specific segments are views.

110. The system of claim 108, wherein said one or more domain-specific segments are events.

111. The system of claim 108, wherein said set of features from said digital video content includes a set of visual features.

112. The system of claim 108, wherein said set of features from said digital video content includes a set of audio features.

113. The system of claim 108, wherein said extracting means further comprises a means for recognizing speech signals.

114. The system of claim 113, wherein said means for recognizing speech signals further converts said speech signals into recognized text data.

115. The system of claim 108, wherein extracting means further comprises a means for decoding closed caption information from said digital video content.

116. The system of claim 108, wherein said extracting means further detect text images in said digital video content and convert said text images into text information.

117. The system of claim 116, wherein said extracting means computes a set of frame-to-frame motion measures, compares said set of frame-to-frame motion measures with a set of predetermined threshold values to determine one or more candidate text areas.

118. The system of claim 117, wherein said extracting means further removes noise from said one or more candidate text areas.

119. The system of claim 118, wherein said extracting means further applies domain-specific spatio-temporal constraints to remove detection errors from said one or more candidate areas.

120. The system of claim 119, wherein said extracting means further applies color-histogram filtering on said one or more candidate text areas to remove detection errors.

121. The system of claim 108, wherein said extracting means further synchronizes a timing information between said set of features.

122. The system of claim 108, wherein said extracting means further comprises a detector of scene changes.

123. The system of claim 122, wherein said detector of scene changes further comprises an automatic flashlight detector.

124. The system of claim 123, wherein said automatic flashlight detector further comprises a comparator for comparing a ratio of a frame-to-frame color difference for each frame to a corresponding long-term color difference to detect flashlights.

125. The system of claim 122, wherein said detector of scene changes further comprises an automatic detector of direct scene changes.

126. The system of claim 122, wherein said detector of scene changes further comprises an automatic detector of gradual scene changes.

127. The system of claim 122, wherein said detector of scene changes further comprises a detector of camera aperture changes.

128. The system of claim 122, wherein said set of pre-determined domain-specific cues is determined based on user preferences.

129. The system of claim 108, wherein said a means for recognizing one or more domain-specific segments further comprises a fast adaptive color filter for selecting possible domain-specific segments.

130. The system of claim 129, wherein said adaptive color filter uses one or more pre-trained filtering models built through a clustering-based training.

131. The system of claim 130, wherein said means for recognizing one or more domain-specific segments further comprises a segmentation-based verification module for verifying domain-specific segments based on a set of pre-determined domain-specific parameters.

132. The system of claim 131, wherein said segmentation-based verification module further comprises a salient-feature region extraction module.

133. The system of claim 132, wherein said segmentation-based verification module further comprises a moving object detection module.

134. The system of claim 133, wherein said segmentation-based verification module further comprises a similarity matching of visual and structure features module.

135. The system of claim 134, wherein said means for recognizing one or more domain-specific segments further comprises an edge-based verification module for verifying domain-specific segments based on a set of pre-determined domain-specific parameters.
